(19) United States
(12) Patent Application Publication
(10) Pub. No.: US 2021/0035172 A1
(43) Pub. Date: Feb. 4, 2021

(54) SYSTEMS AND METHODS FOR TRANSPORT PRICING

(71) Applicant: BEIJING DIDI INFINITY TECHNOLOGY AND DEVELOPMENT CO., LTD., Beijing (CN)

(72) Inventors: Hengzhi WANG, Hangzhou (CN); Licai QI, Hangzhou (CN); Yifei ZHANG, Hangzhou (CN); Fan TENG, Hangzhou (CN)

(73) Assignee: BEIJING DIDI INFINITY TECHNOLOGY AND DEVELOPMENT CO., LTD., Beijing (CN)

(21) Appl. No.: 17/073,485

(22) Filed: Oct. 19, 2020

Related U.S. Application Data
(63) Continuation of application No. PCT/CN2019/083535, filed on Apr. 19, 2019.

(30) Foreign Application Priority Data
Apr. 19, 2018 (CN) 201810354349.3
May 30, 2018 (CN) 201810541256.1
May 31, 2018 (CN) 201810547664.8

(51) Int. Cl. G06Q 30/02; G06Q 50/30; G06Q 10/06; G06F 17/18; G06N 20/00

(52) U.S. Cl. CPC G06Q 30/0284; G06Q 50/30; G06N 20/00; G06Q 10/067; G06F 17/18; G06Q 30/0202

(57) ABSTRACT

The present disclosure is related to systems and methods for transport pricing. The method includes determining an actual service cost and a preset service cost of each of historical orders, and an actual order count corresponding to the preset service cost. The method also includes determining, based on the actual service cost of each of the historical orders, an actual total turnover. The method further includes determining a fitting function with the total turnover as a dependent variable, and a conversion rate and a price adjustment ratio as an independent variable.

### CROSS-REFERENCE TO RELATED APPLICATIONS

This application is a continuation of International Application No. PCT/CN2019/083535 filed on Apr. 19, 2019, which claims priority of Chinese Patent Application No. 201810354349.3, filed on Apr. 19, 2018, Chinese Patent Application No. 201810547664.8, filed on May 31, 2018, and Chinese Patent Application No. 201810541256.1, filed on May 30, 2018, the contents of each of which are incorporated herein by reference.

### TECHNICAL FIELD

This disclosure generally relates to the field of transport pricing technology, and more particularly, relates to systems and methods for adjusting an estimated service cost for an order.

### BACKGROUND

Gross merchandise volume (GMV) is a total turnover of a platform (e.g., a transport platform) within a certain time period. As a transaction indicator, GMV is an important indicator for evaluating the platform. GMV may also be used as an indicator to test the health of the transaction of the platform. The GMV of a transport platform within a time period may be determined based on an actual service cost of each of orders and a count of the orders within the time period. Generally, a service cost of an order may be preset according to such as market competition to increase a market share of the transport platform. The service cost of an order determined according to such as market competition may be decreased, which may also decrease the willingness of a driver to receive the order, and decrease the GMV of the transport platform. Therefore, it is desirable to provide systems and methods for transport pricing to improve the total turnover of the transport platform.

### SUMMARY

According to an aspect of the present disclosure, a method may include one or more of the following operations performed by at least one processor. The method may include, in response to information of a plurality of orders in a specific time period, determining, based on a preset constraint between a total turnover and a service cost, an estimated service cost associated with each of at least a portion of the plurality of orders.

In some embodiments, the estimated service cost may have a fitting relationship with an estimated starting distance, a cost for the estimated starting distance, and a unit price of distances excluding the estimated starting distance. The fitting relationship may be determined based on a service cost of each of historical orders, a historical starting distance of each of the historical orders, a cost for the historical starting distance of each of the historical orders, and a unit price of distances excluding the corresponding historical starting distance of each of the historical orders.

In some embodiments, the method may include determining, based on the preset constraint, a range of the estimated service cost associated with the each of at least a portion of the plurality of orders when an estimated total turnover exceeds a preset total turnover and an estimated order count exceeds a preset order count in the specific time period.

In some embodiments, the preset constraint may be determined by a method. The method may include obtaining data associated with historical orders. The method may include determining, statistically, a relationship between the service cost and a conversion rate based on the data associated with the historical orders. The method may include determining a mapping relationship between a travel distance and an estimated order count based on the data associated with the historical orders. The method may include determining, based on the relationship between the service cost and the conversion rate and the mapping relationship between the travel distance and the estimated order count associated with the historical orders, the preset constraint.

In some embodiments, the method may include analyzing, corresponding to the service cost of each of the historical orders, the historical starting distance of each of the historical orders, the cost for the historical starting distance of each of the historical orders, and the unit price of distances excluding the corresponding historical starting distance of each of the historical orders. The method may include determining, based on the service cost of each of the historical orders, the historical starting distance of each of the historical orders, the cost for the historical starting distance of each of the historical orders, and the unit price of distances excluding the corresponding historical starting distance of each of the historical orders, the relationship between the service cost and a conversion rate based on the data associated with the historical orders, and the mapping relationship between the travel distance and the estimated order count associated with the historical orders, the preset constraint.

In some embodiments, the method may include determining the conversation rate corresponding to the service cost of each of the historical orders. The method may include determining, based on the service cost of each of the historical orders and the determined conversation rate corresponding to the service cost of each of the historical orders, the relationship between the conversation rate and the service cost. The conversion rate may be determined based on a ratio of a total order count associated with the historical orders to the estimated order count associated with the historical orders.

In some embodiments, the method may include determining the estimated order count corresponding to the travel distance of each of the historical orders. The method may also include determining, based on the travel distance of each of the historical orders and the determined estimated order count corresponding to the travel distance of each of the historical orders, the mapping relationship between the travel distance and the estimated order count.

In some embodiments, the preset constraint may be determined according to Equation (4) as described elsewhere in the present disclosure.

According to another aspect of the present disclosure, a system for data processing may include at least one storage medium storing a set of instructions and at least one processor in communication with the at least one storage medium. When executing the stored set of instructions, the at least one processor may cause the system to perform the method for data processing.

According to another aspect of the present disclosure, a non-transitory computer readable medium may include at least one set of instructions for data processing. Wherein when executed by at least one processor, the at least one set of instructions may cause the at least one processor to perform the method for data processing.

According to another aspect of the present disclosure, a system for data processing may include an adjustment module. The adjustment module may be configured to in response to information of a plurality of orders in a specific time period, determine, based on a preset constraint between a total turnover and a service cost, an estimated service cost associated with each of at least a portion of the plurality of orders.

According to another aspect of the present disclosure, a method may include one or more of the following operations performed by at least one processor. The method may include, in response to information of a plurality of orders in a specific time period, adjusting, based on a preset constraint between a total order count and a service cost, an estimated service cost associated with each of at least a portion of the plurality of orders.

In some embodiments, the method may include adjusting, based on the preset constraint, the estimated service cost associated with the each of at least a portion of the plurality of orders until the total order count satisfies a preset order count.

In some embodiments, the method may include determining a corresponding relationship between the total order count and a service cost based on historical orders. The method may include determining a fitting function between a conversion rate and the service cost based on the historical orders. The method may include determining, based on the corresponding relationship between the total order count and a service cost and the fitting function between the conversion rate and the service cost, the preset constraint.

In some embodiments, the method may include determining the conversation rate corresponding to the service cost of each of the historical orders. The method may include determining, based on the service cost of each of the historical orders and the determined conversation rate corresponding to the service cost of each of the historical orders, the fitting function between the conversation rate and the service cost. The conversion rate corresponding to the service cost may be determined based on a ratio of a total order count to the estimated order count a fitting function between a conversion rate and the service cost corresponding to the service cost.

In some embodiments, the method may include determining an estimated order count in each distance range corresponding to one of the historical orders and the fitting function. The method may include determining, based on the estimated order count, the fitting function, and the corresponding relationship between the total order count and the service cost associated with the historical orders, the preset constraint between the total order count and the estimated service cost.

In some embodiments, the preset constraint may be determined according to Equation (21) as described elsewhere in the present disclosure.

According to another aspect of the present disclosure, a system for data processing may include at least one storage medium storing a set of instructions, and at least one processor in communication with the at least one storage medium. When executing the stored set of instructions, the at least one processor may cause the system to perform the method for data processing.

According to another aspect of the present disclosure, a non-transitory computer readable medium may include at least one set of instructions for data processing. Wherein when executed by at least one processor, the at least one set of instructions may cause the at least one processor to perform the method for data processing.

According to another aspect of the present disclosure, a system for data processing may include a calculation module. The calculation module may be configured to, in response to information of a plurality of orders in a specific time period, adjust, based on a preset constraint between a total order count and a service cost, an estimated service cost associated with each of at least a portion of the plurality of orders.

According to another aspect of the present disclosure, a method may include one or more of the following operations performed by at least one processor. The method may include determining an actual service cost and a preset service cost of each of historical orders, and an actual order count corresponding to the preset service cost. The method may include determining, based on the actual service cost of each of the historical orders, an actual total turnover. The method may include determining a fitting function with the total turnover as a dependent variable, and a conversion rate and a price adjustment ratio as an independent variable. The conversion rate may denote a ratio of the actual order count and an estimated order count. The price adjustment ratio may be a ratio of the actual service cost and the preset service cost.

In some embodiments, the method may include, for each of the historical orders, detecting whether a client terminal associated with a passenger confirms the receipt of the price adjustment ratio and initiates the each of the historical orders to determine a demand conversation rate. The method may also include detecting whether a client terminal associated with a driver confirms the receipt of the price adjustment ratio and the each of the historical orders to determine the conversion rate. The method may further include fitting the demand conversation rate and the conversion rate to determine a first corresponding relationship between the price adjustment ratio and the conversion rate.

In some embodiments, the method may include determining the preset service cost, a preset demand amount corresponding to the preset service cost, and an actual demand amount. The method may include determining a ratio between the preset demand amount and the actual demand amount. The method may include fitting the preset service cost and the ratio between the preset demand amount and the actual demand amount to determine a second corresponding relationship.

In some embodiments, the method may include determining, based on an operation time corresponding to each of the historical orders, a distribution function of the actual demand amount with respect to a specific time period.

In some embodiments, the method may include determining a product between the first relationship, the second relationship, the preset service cost, and the price adjustment ratio with respect to the specific time period. The method may include determining an accumulation of the product when the preset service cost satisfies a discrete distribution. The method may include multiplying the accumulation and the distribution function of the actual demand amount to determine the total turnover.

In some embodiments, the method may include determining a product between the first relationship, the second relationship, the preset service cost, and the price adjustment ratio with respect to the specific time period. The method may include performing an integral operation on the product when the preset service cost satisfies a continuous distribution. The method may include multiplying an integral result and the distribution function of the actual demand amount to determine the total turnover, wherein a maximum of the preset service cost an integral range of the integral operation ≥0.

In some embodiments, the method may include determining a conversation rate model providing a relationship between a conversation rate and the service cost based on the actual service cost and the preset service cost of each of historical orders, and then actual order count corresponding to the preset service cost. The method may include determining a demand amount distribution model based on the historical orders, the demand amount distribution model providing a relationship between the service cost, an estimated demand amount and an actual demand amount. The method may include determining an actual demand amount model providing a relationship between the actual demand amount and a time period. The method may include determining the fitting function based on the conversation rate model, the demand amount distribution model, and the actual demand amount model.

In some embodiments, the method may include obtaining one or more specific orders. The method may include determining a price adjustment ratio for each of at least a portion of the one or more specific orders based on the fitting function. The method may include adjusting a preset service cost for each of at least a portion of the one or more specific orders based on the determined price adjustment ratio.

According to another aspect of the present disclosure, a system for transport pricing may include at least one storage medium storing a set of instructions, and at least one processor in communication with the at least one storage medium. When executing the stored set of instructions, the at least one processor may cause the system to perform the method for transport pricing.

According to another aspect of the present disclosure, a non-transitory computer readable medium may include at least one set of instructions for transport pricing. Wherein when executed by at least one processor, the at least one set of instructions may cause the at least one processor to perform the method for transport pricing.

According to another aspect of the present disclosure, a system for transport pricing may include a determination module and a fitting module. The determination module may be configured to determine an actual service cost and a preset service cost of each of historical orders, and an actual order count corresponding to the preset service cost. The determination module may also be configured to determine, based on the actual service cost of each of the historical orders, a total turnover. The fitting module may be configured to determine a fitting function with the total turnover as a dependent variable, and a conversion rate and price adjustment ratio as an independent variable. The conversion rate may be a ratio of the actual order count and an estimated order count. The price adjustment ratio may be a ratio of the actual service cost and the preset service cost.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. The drawings are not to scale. These embodiments are non-limiting exemplary embodiments, in which like reference numerals represent similar structures throughout the several views of the drawings, and wherein:

FIG. 1 is a schematic diagram illustrating an exemplary online to offline system according to some embodiments of the present disclosure;

FIG. 2 is a schematic diagram illustrating exemplary components of a computing device according to some embodiments of the present disclosure;

FIG. 3 is a schematic diagram illustrating exemplary hardware and/or software components of an exemplary mobile device according to some embodiments of the present disclosure;

FIG. 4 is a block diagram illustrating an exemplary processing engine according to some embodiments of the present disclosure;

FIG. 5 is a flowchart illustrating an exemplary process for transport pricing according to some embodiments of the present disclosure;

FIG. 6 is a flowchart illustrating an exemplary process for optimizing a total turnover according to some embodiments of the present disclosure;

FIG. 7 is a block diagram illustrating an exemplary processing engine according to some embodiments of the present disclosure;

FIG. 8 is a flowchart illustrating an exemplary process for data processing according to some embodiments of the present disclosure;

FIG. 9 is a flowchart illustrating an exemplary process for optimizing a total turnover according to some embodiments of the present disclosure;

FIG. 10 is a block diagram illustrating an exemplary processing engine according to some embodiments of the present disclosure;

FIG. 11 is a flowchart illustrating an exemplary process for data processing according to some embodiments of the present disclosure; and

FIG. 12 is a flowchart illustrating an exemplary process for optimizing a total order count according to some embodiments of the present disclosure.

### DETAILED DESCRIPTION

In order to illustrate the technical solutions related to the embodiments of the present disclosure, brief introduction of the drawings referred to in the description of the embodiments is provided below. Obviously, drawings described below are only some examples or embodiments of the present disclosure. Those having ordinary skills in the art, without further creative efforts, may apply the present disclosure to other similar scenarios according to these drawings. Unless stated otherwise or obvious from the context, the same reference numeral in the drawings refers to the same structure and operation.

As used in the disclosure and the appended claims, the singular forms “a,” “an,” and “the” include plural referents unless the content clearly dictates otherwise. It will be further understood that the terms “comprises,” “comprising,” “includes,” and/or “including” when used in the disclosure, specify the presence of stated steps and elements, but do not preclude the presence or addition of one or more other steps and elements.

Some modules of the system may be referred to in various ways according to some embodiments of the present disclosure, however, any number of different modules may be used and operated in a client terminal and/or a server. These modules are intended to be illustrative, not intended to limit the scope of the present disclosure. Different modules may be used in different aspects of the system and method.

According to some embodiments of the present disclosure, flowcharts are used to illustrate the operations performed by the system. It is to be expressly understood, the operations above or below may or may not be implemented in order. Conversely, the operations may be performed in inverted order, or simultaneously. Besides, one or more other operations may be added to the flowcharts, or one or more operations may be omitted from the flowchart.

Technical solutions of the embodiments of the present disclosure be described with reference to the drawings as described below. It is obvious that the described embodiments are not exhaustive and are not limiting. Other embodiments obtained, based on the embodiments set forth in the present disclosure, by those with ordinary skill in the art without any creative works are within the scope of the present disclosure.

Moreover, the systems and methods in the present disclosure may be applied to any application scenario in which transport pricing is required. For example, the system or method of the present disclosure may be applied to different transportation systems including land, ocean, aerospace, or the like, or any combination thereof. The transportation systems may provide transportation service for users using various vehicles. The vehicles of the transportation service may include a taxi, a private car, a hitch, a bus, a train, a bullet train, a high speed rail, a subway, a vessel, an aircraft, a spaceship, a hot-air balloon, a driverless vehicle, a bicycle, a tricycle, a motorcycle, or the like, or any combination thereof. The system or method of the present disclosure may be applied to a taxi hailing service, a chauffeur service, a delivery service, a carpooling service, a bus service, a take-out service, a driver hiring service, a shuttle service, a travel service, or the like, or any combination thereof. As another example, the system or method of the present disclosure may be applied to a navigation service, a shopping service, a house service, a location based service (LBS), or the like, or any combination thereof. The application scenarios of the system or method of the present disclosure may include a web page, a plug-in of a browser, a client terminal, a custom system, an internal analysis system, an artificial intelligence robot, or the like, or any combination thereof.

An aspect of the present disclosure is directed to systems and methods for data processing. In response to information of a plurality of orders in a specific time period, the systems and methods may adjust, based on a preset constraint between a total turnover and a service cost, an estimated service cost associated with each of at least a portion of the plurality of orders.

Another aspect of the present disclosure is directed to systems and methods for data processing. In response to information of a plurality of orders in a specific time period, the systems and methods may adjust, based on a preset constraint between a total order count and a service cost, an estimated service cost associated with each of at least a portion of the plurality of orders.

Another aspect of the present disclosure is directed to systems and methods for transport pricing. The systems and methods may determine an actual service cost and a preset service cost of each of historical orders, and an actual order count corresponding to the preset service cost. The systems and methods may determine, based on the actual service cost of each of the historical orders, a total turnover. The systems and methods may determine a fitting function with the total turnover as a dependent variable, and a conversion rate and price adjustment ratio as an independent variable. Accordingly, the systems and methods may adjust the preset service cost based on an optimal price adjustment ratio determined based on the fitting function.

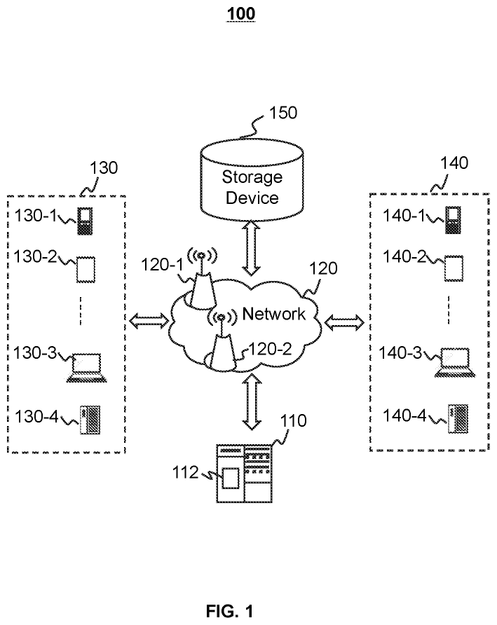

FIG. 1 is a block diagram of an exemplary online to offline system 100 according to some embodiments. For example, the online to offline system 100 may be a system for a transportation service (e.g., a taxi hailing service, a chauffeur service, a delivery service, a carpool service, a bus service, a take-out service, a driver hiring service, a vehicle hiring service, a train service, a subway service, a shuttle service), a shopping service, a deliver service, or the like.

The online to offline system 100 may include a server 110, a network 120, one or more client terminals (e.g., one or more requestor terminals 130, one or more provider terminals 140), and a storage device 150.

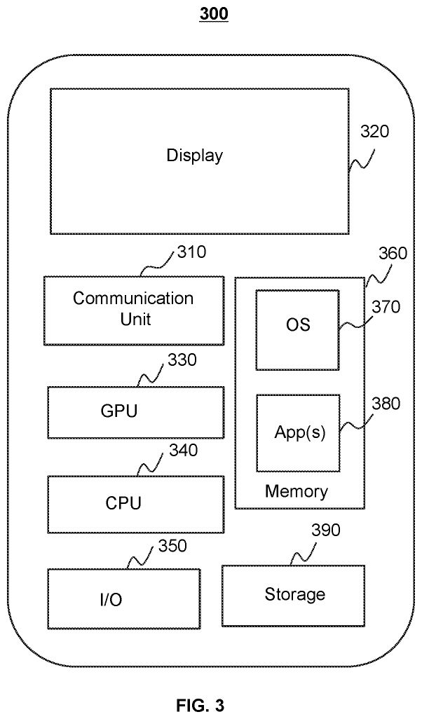

In some embodiments, the server 110 may be a single server, or a server group. The server group may be centralized, or distributed (e.g., the server 110 may be a distributed system). In some embodiments, the server 110 may be local or remote. For example, the server 110 may access information and/or data stored in the one or more client terminals (e.g., the one or more requestor terminals 130, the one or more provider terminals 140), and/or the storage device 150 via the network 120. As another example, the server 110 may be directly connected to the one or more client terminals (e.g., the one or more requestor terminals 130, the one or more provider terminals 140), and/or the storage device 150 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 300 having one or more components illustrated in FIG. 3 in the present disclosure.

In some embodiments, the server 110 may include a processing engine 112. The processing engine 112 may process information and/or data to perform one or more functions described in the present disclosure. For example, in response to information of a plurality of orders in a specific time period, the processing engine 112 may adjust, based on a preset constraint between a total turnover and a service cost, an estimated service cost associated with each of at least a portion of the plurality of orders. As another example, in response to information of a plurality of orders in a specific time period, the processing engine 112 may adjust, based on a preset constraint between a total order count and a service cost, an estimated service cost associated with each of at least a portion of the plurality of orders. As still another example, the processing engine 112 may determine an actual service cost and a preset service cost of each of historical orders, and an actual order count corresponding to the preset service cost. As still another example, the processing engine 112 may determine, based on the actual service cost of each of the historical orders, a total turnover. As still another example, the processing engine 112 may determine a fitting function with the total turnover as a dependent variable, and a conversion rate and price adjustment ratio as an independent variable. As still another example, the processing engine 112 may obtain a plurality of orders provided by an online to offline platform during a current time period. As still another example, the processing engine 112 may determine a price adjustment ratio for each of a plurality of orders. As still another example, the processing engine 112 may adjust a preset service cost for at least a portion of a plurality of orders based on a price adjustment ratio.

In some embodiments, the processing engine 112 may include one or more processing engines (e.g., signal-core processing engine(s) or multi-core processor(s)). Merely by way of example, the processing engine 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field-programmable gate array (FPGA), a programmable logic device (PLD), a controller, a microcontroller unit, a reduced instruction-set computer (RISC), a microprocessor, or the like, or any combination thereof.

The network 120 may facilitate exchange of information and/or data. In some embodiments, one or more components in the online to offline system 100 (e.g., the server 110, the one or more requestor terminals 130, the one or more provider terminal 140, or the storage device 150) may send information and/data to other component(s) in the online to offline system 100 via the network 120. For example, the processing engine 112 may obtain a plurality of historical orders and/or a plurality of service requests from the one or more client terminals (e.g., the one or more requestor terminals 130, the one or more provider terminals 140) and/or the storage device 150 via the network 120. As another example, the processing engine 112 may obtain a preset constraint between a total turnover and a service cost from the storage device 150 via the network 120. As another example, the processing engine 112 may obtain a preset constraint between a total order count and a service cost from the storage device 150 via the network 120. In some embodiments, the network 120 may be any type of wired or wireless network, or any combination thereof. Merely by way of example, the network 120 may include a cable network, a wireline network, an optical fiber network, a telecommunications network, an intranet, an internet, a local area network (LAN), a wide area network (WAN), a wireless local area network (WLAN), a metropolitan area network (MAN), a wide area network (WAN), a public telephone switched network (PTSN), a Bluetooth network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2 . . . through which one or more components of the online to offline system 100 may be connected to the network 120 to exchange data and/or information.

In some embodiments, the requestor terminal 130 may include a mobile device 130-1, a tablet computer 130-2, a laptop computer 130-3, a built-in device in a motor vehicle 130-4, or the like, or any combination thereof. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or combination thereof. In some embodiments, the wearable device may include a smart bracelet, a smart footgear, a smart glass, a smart helmet, a smart watch, a smart clothing, a smart backpack, a smart accessory, or the like, or any combination thereof. In some embodiments, the smart mobile device may include a smartphone, a personal digital assistance (PDA), a gaming device, a navigation device, a point of sale (POS) device, or the like, or any combination. In some embodiments, the virtual reality device and/or the augmented reality device may include a virtual reality helmet, a virtual reality glass, a virtual reality patch, an augmented reality helmet, an augmented reality glass, an augmented reality patch, or the like, or any combination thereof. For example, the virtual reality device and/or the augmented reality device may include a Google Glass, an Oculus Rift, a Hololens, a Gear VR, etc. In some embodiments, built-in device in the motor vehicle 130-4 may include an onboard computer, an onboard television, etc. In some embodiments, the requestor terminal 130 may be a device with positioning technology for locating the position of the service requester and/or the requestor terminal 130.

In some embodiments, the provider terminal 140 may be similar to, or the same device as the requestor terminal 130. In some embodiments, the provider terminal 140 may be a device with positioning technology for locating the position of the driver and/or the provider terminal 140. In some embodiments, the requestor terminal 130 and/or the provider terminal 140 may communicate with other positioning device to determine the position of the service requester, the requestor terminal 130, the service provider, and/or the provider terminal 140. In some embodiments, the requestor terminal 130 and/or the provider terminal 140 may send positioning information to the server 110.

The storage device 150 may store data and/or instructions. For example, the data may be a training model, one or more training samples, historical orders, or the like, or a combination thereof. In some embodiments, the storage device 150 may store data obtained from the one or more client terminals (e.g., the one or more requestor terminals 130, provider terminals 140). For example, the storage device 150 may store a preset constraint between a total order count and a service cost determined by the processing engine 112. As another example, the storage device 150 may store a preset constraint between a total turnover and a service cost determined by the processing engine 112. In some embodiments, the storage device 150 may store data and/or instructions that the server 110 may execute or use to perform exemplary methods described in the present disclosure. For example, the storage device 150 may store instructions that the processing engine 112 may execute or use to adjust, based on a preset constraint between a total turnover and a service cost, an estimated service cost associated with an order. As another example, the storage device 150 may store instructions that the processing engine 112 may execute or use to adjust, based on a preset constraint between a total order count and a service cost, an estimated service cost associated with an order. As still another example, the storage device 150 may store instructions that the processing engine 112 may execute or use to determine an actual service cost and a preset service cost of each of historical orders, and an actual order count corresponding to the preset service cost. As still another example, the storage device 150 may store instructions that the processing engine 112 may execute or use to determine, based on the actual service cost of each of the historical orders, a total turnover. As still another example, the storage device 150 may store instructions that the processing engine 112 may execute or use to determine a fitting function with the total turnover as a dependent variable, and a conversion rate and price adjustment ratio as an independent variable.

In some embodiments, the storage device 150 may include a mass storage, a removable storage, a volatile read-and-write memory, a read-only memory (ROM), or the like, or any combination thereof. Exemplary mass storage may include a magnetic disk, an optical disk, a solid-state drives, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically-erasable programmable ROM (EEPROM), a compact disk ROM (CD-ROM), and a digital versatile disk ROM, etc. In some embodiments, the storage device 150 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage device 150 may be connected to the network 120 to communicate with one or more components in the online to offline system 100 (e.g., the server 110, the one or more client terminals, etc.). One or more components in the online to offline system 100 may access the data and/or instructions stored in the storage device 150 via the network 120. In some embodiments, the storage device 150 may be directly connected to or communicate with one or more components in the online to offline system 100 (e.g., the server 110, the one or more client terminals, etc.). In some embodiments, the storage device 150 may be part of the server 110.

It should be noted that the online to offline system 100 is merely provided for the purposes of illustration, and is not intended to limit the scope of the present disclosure. For persons having ordinary skills in the art, multiple variations or modifications may be made under the teachings of the present disclosure. For example, the online to offline system 100 may further include a database, an information source, or the like. As another example, the online to offline system 100 may be implemented on other devices to realize similar or different functions. However, those variations and modifications do not depart from the scope of the present disclosure.

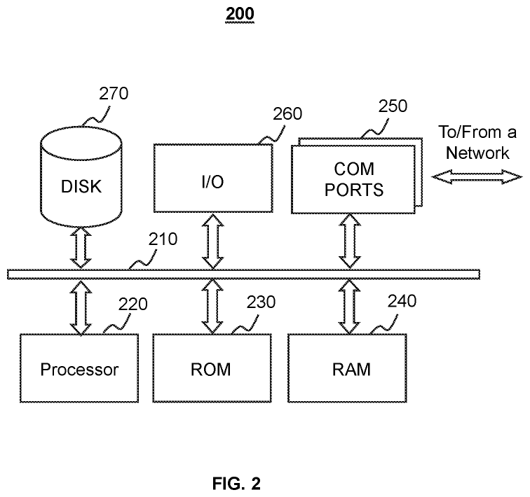

FIG. 2 is a schematic diagram illustrating exemplary components of a computing device on which the server 110, the storage device 150, and/or the client terminal (e.g., the requestor terminal 130, the provider terminal 140) may be implemented according to some embodiments of the present disclosure. A particular system (e.g., the online to offline system 100) may use a functional block diagram to explain the hardware platform containing one or more user interfaces. The computer may be a computer with general or specific functions. Both types of the computers may be configured to implement any particular system (e.g., the online to offline system 100) according to some embodiments of the present disclosure. Computing device 200 may be configured to implement any components that perform one or more functions disclosed in the present disclosure. For example, the computing device 200 may implement any component of the online to offline system 100 as described herein. In FIGS. 1-2, only one such computer device is shown purely for convenience purposes. One of ordinary skill in the art would understood at the time of filing of this application that the computer functions relating to transport pricing as described herein may be implemented in a distributed fashion on a number of similar platforms, to distribute the processing load.

The computing device 200, for example, may include COM ports 250 connected to and from a network connected thereto to facilitate data communications. The computing device 200 may also include a processor (e.g., the processor 220), in the form of one or more processors (e.g., logic circuits), for executing program instructions. For example, the processor may include interface circuits and processing circuits therein. The interface circuits may be configured to receive electronic signals from a bus 210, wherein the electronic signals encode structured data and/or instructions for the processing circuits to process. The processing circuits may conduct logic calculations, and then determine a conclusion, a result, and/or an instruction encoded as electronic signals. Then the interface circuits may send out the electronic signals from the processing circuits via the bus 210.

The exemplary computing device may include the internal communication bus 210, program storage and data storage of different forms including, for example, a disk 270, and a read only memory (ROM) 230, or a random access memory (RAM) 240, for various data files to be processed and/or transmitted by the computing device. The exemplary computing device may also include program instructions stored in the ROM 230, RAM 240, and/or other type of non-transitory storage medium to be executed by the processor 220. The methods and/or processes of the present disclosure may be implemented as the program instructions. The computing device 200 also includes an I/O component 260, supporting input/output between the computer and other components. The computing device 200 may also receive programming and data via network communications.

Merely for illustration, only one CPU and/or processor is illustrated in FIG. 2. Multiple CPUs and/or processors are also contemplated; thus operations and/or method steps performed by one CPU and/or processor as described in the present disclosure may also be jointly or separately performed by the multiple CPUs and/or processors. For example, if in the present disclosure the CPU and/or processor of the computing device 200 executes both step A and step B, it should be understood that step A and step B may also be performed by two different CPUs and/or processors jointly or separately in the computing device 200 (e.g., the first processor executes step A and the second processor executes step B, or the first and second processors jointly execute steps A and B).

FIG. 3 is a schematic diagram illustrating exemplary hardware and/or software components of an exemplary mobile device according to some embodiments of the present disclosure; on which the client terminal (e.g., the requestor terminal 130, the provider terminal 140) may be implemented according to some embodiments of the present disclosure. As illustrated in FIG. 3, the mobile device 300 may include a communication platform 310, a display 320, a graphic processing unit (GPU) 330, a central processing unit (CPU) 340, an I/O 350, a memory 360, and a storage 390. The CPU 340 may include interface circuits and processing circuits similar to the processor 220. In some embodiments, any other suitable component, including but not limited to a system bus or a controller (not shown), may also be included in the mobile device 300. In some embodiments, a mobile operating system 370 (e.g., iOS™, Android™, Windows Phone™, etc.) and one or more applications 380 may be loaded into the memory 360 from the storage 390 in order to be executed by the CPU 340. The applications 380 may include a browser or any other suitable mobile apps for receiving and rendering information relating to a request or other information from the online to offline system on the mobile device 300. User interactions with the information stream may be achieved via the I/O devices 350 and provided to the processing engine 112 and/or other components of the online to offline system 100 via the network 120.

In order to implement various modules, units and their functions described above, a computer hardware platform may be used as hardware platforms of one or more elements (e.g., a component of the sever 110 described in FIG. 2). Since these hardware elements, operating systems, and program languages are common, it may be assumed that persons skilled in the art may be familiar with these techniques and they may be able to provide information required in transport pricing according to the techniques described in the present disclosure. A computer with user interface may be used as a personal computer (PC), or other types of workstations or terminal devices. After being properly programmed, a computer with user interface may be used as a server. It may be considered that those skilled in the art may also be familiar with such structures, programs, or general operations of this type of computer device. Thus, extra explanations are not described for the figures.

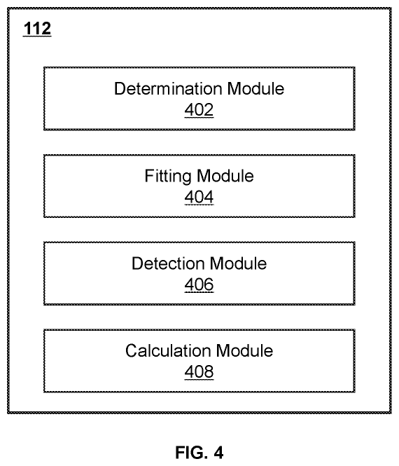

FIG. 4 is a block diagram illustrating an exemplary processing engine 112 according to some embodiments of the present disclosure. In some embodiments, the processing engine 112 may include a determination module 402, a fitting module 404, a detection module 406, and a calculation module 408. The modules may be hardware circuits of at least part of the processing engine 112. The modules may also be implemented as an application or set of instructions read and executed by the processing engine 112. Further, the modules may be any combination of the hardware circuits and the application/instructions. For example, the modules may be part of the processing engine 112 when the processing engine 112 is executing the application or set of instructions.

The determination module 402 may be configured to determine information associated with the online to offline system 100. For example, the determination module 402 may determine an actual service cost and a preset service cost of each of historical orders, and an actual order count corresponding to the preset service cost. As another example, the determination module 402 may determine, based on an actual service cost of each of historical orders, a total turnover. As still another example, the determination module 402 may determine a preset service cost, a preset demand amount corresponding to the preset service cost, and an actual demand amount. As still another example, the determination module 402 may determine, based on an operation time corresponding to each of historical orders, a distribution function of an actual demand amount with respect to a specific time period.

The fitting module 404 may be configured to determine a fitting function. For example, the fitting module 404 may determine a fitting function with a total turnover as a dependent variable, and a conversion rate and a price adjustment ratio as an independent variable. As another example, the fitting module 404 may fit a demand conversation rate and a conversion rate to determine a first corresponding relationship between a price adjustment ratio and the conversion rate. As still another example, the fitting module 404 may fit a preset service cost and a ratio between a preset demand amount and an actual demand amount to determine a second corresponding relationship.

The detection module 406 may be configured to detect information associated with the online to offline system 100. For example, for each of historical orders, the detection module 406 may detect whether a client terminal associated with a passenger confirms the receipt of a price adjustment ratio and initiates the each of the historical orders to determine a demand conversation rate. As another example, the detection module 406 may detect whether a client terminal associated with a driver confirms receipt of a price adjustment ratio and the each of the historical orders to determine the conversion rate.

The calculation module 408 may be configured to determine information associated with the online to offline system 100. In some embodiments, the calculation module 408 may determine a ratio between a preset demand amount and an actual demand amount. In some embodiments, the calculation module 408 may determine a total turnover. For example, the calculation module 408 may determine a product between a first corresponding relationship, a second corresponding relationship, a preset service cost, and a price adjustment ratio with respect to a specific time period. The calculation module 408 may determine an accumulation of a product when a preset service cost satisfies a discrete distribution. The calculation module 408 may multiply an accumulation and a distribution function of an actual demand amount to determine a total turnover. As another example, the calculation module 408 may determine a product between a first relationship, a second relationship, a preset service cost, and a price adjustment ratio with respect to a specific time period. The calculation module 408 may perform an integral operation on a product when a preset service cost satisfies a continuous distribution. The calculation module 408 may multiply an integral result and a distribution function of an actual quantity to determine a total turnover, wherein a maximum of the preset service cost an integral range of the integral operation ≥0.

In some embodiments, the accuracy of determining the price adjustment ratio of each of the historical orders may be improved by referring to the actual service cost, the preset service cost, and the actual order count of the each of the historical orders. By determining the fitting function with the conversion rate and the price adjustment ratio as the independent variables, and the total turnover as the dependent variable, the conversion rate and the price adjustment ratio may be two main factors for determining the total turnover, rather than a relationship between supply and demand. The total turnover of a transport platform (e.g., a taxi service platform) where the supply and the demand are balanced may be increased.

In some embodiments, the fitting function of the total turnover, the preset service cost, and the price adjustment ratio may be determined based on a relationship between the actual service cost, the preset service cost, and the actual order count. The accuracy of the total turnover determination based on the preset service cost and price adjustment ratio may be improved. The accuracy and the rationality of the preset service cost and the price adjustment ratio may be improved. Therefore, the competitiveness of the transport platform may further be improved.

In some embodiments, the preset service cost and the price adjustment ratio may be determined based on a preset total turnover. Since the price adjustment ratio is determined by comprehensively considering the willingness of a passenger to initiate an order and the willingness of a driver to accept the order, the accuracy of determining the price adjustment ratio may be effectively improved. Therefore, the market share and the total turnover of the transport platform may be improved.

In some embodiments, by determining the demand conversation rate, the corresponding conversion rate, and the first corresponding relationship between the price adjustment ratio and the conversion rate, the accuracy of conversion rate determination corresponding to the price adjustment ratio may be improved. The relationship between the price adjustment ratio and the conversion rate may be determined by using a fitting technique. Accordingly, the accuracy of the determination of the first corresponding relationship between the price adjustment ratio and the conversion rate (e.g., the conversion rate model) may be improved, which may improve the accuracy of determining the conversion rate and the total turnover.

In some embodiments, by determining the ratio of the preset demand amount and the actual demand amount, and the second corresponding relationship between the preset service cost and the ratio of the preset demand amount and the actual demand amount using the fitting technique, the accuracy of the determination of the second corresponding relationship (e.g., the demand amount model) may be improved. That is, the ratio of the preset demand amount and the actual demand amount may be increased by adjusting the preset service cost, the accuracy and the rationality of determining the total turnover of the transport platform may further be improved.

In some embodiments, for the transport platform where the supply and the demand are balanced, the relationship between the supply and the demand in different time periods may be different. For example, the capacity demand during peak hours of commuting may be larger than the capacity supply, that is, the capacity may be tight. The capacity may be relatively less tight during other time periods. Therefore, by determining the distribution function of the actual demand amount with respect to the specific time period based on the operation time corresponding to the each of the historical orders, the real-time feature and the accuracy of the actual demand amount may be improved, which may be beneficial to optimize the transport pricing strategy under different operation times. Therefore, the total turnover and the competitiveness of the transport platform may further be improved.

In some embodiments, by determining the product between the first corresponding relationship, the second corresponding relationship, the preset service cost, and the price adjustment ratio with respect to the specific time period, the preset service cost may be determined. When the preset service cost satisfies the discrete distribution, the accumulation of the product may be determined. The accumulation and the distribution function of the actual quantity may be multiplied to determine the total turnover. The accuracy and the rationality of determining the total turnover of the transport platform may be improved.

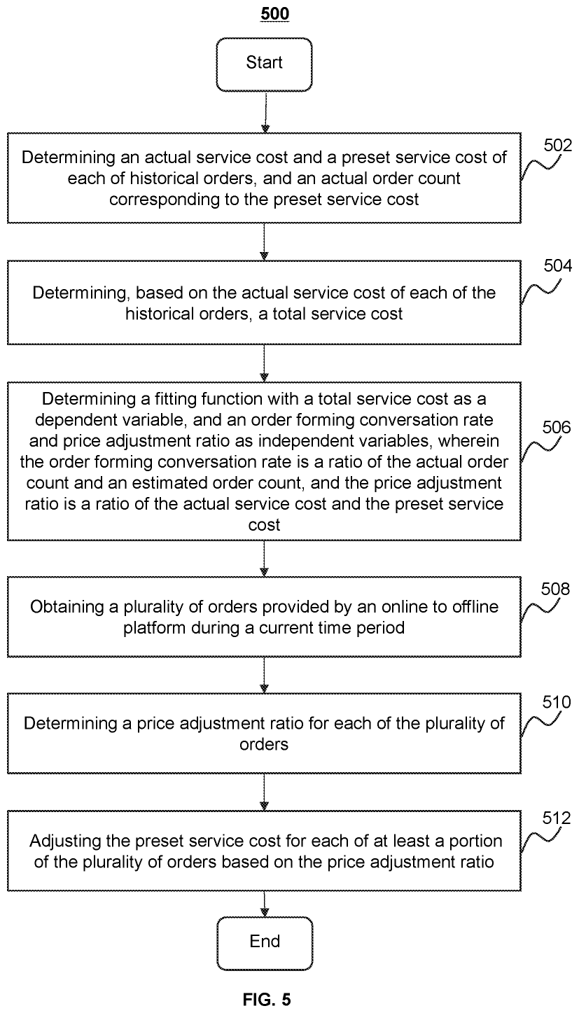

In some embodiments, after determining the first corresponding relationship and the second corresponding relationship according to the fitting technique, when the preset service cost satisfies the discrete distribution, the total turnover may be determined according to Equation (1) as described elsewhere in the present disclosure (e.g., FIG. 5 and descriptions thereof).

In some embodiments, by determining the product between the first corresponding relationship, the second corresponding relationship, the preset service cost, and the price adjustment ratio with respect to the specific time period, the preset service cost may be determined. When the preset service cost satisfies the continuous distribution, the integral operation may be performed on the product. The integral result and the distribution function of the actual quantity may be multiplied to determine the total turnover. The accuracy and the rationality of determining the total turnover of the transport platform may be improved.

In some embodiments, after determining the first corresponding relationship and the second corresponding relationship according to the fitting technique, when the preset service cost satisfies the continuous distribution, the total turnover may be determined according to Equation (2) as described elsewhere in the present disclosure (e.g., FIG. 5 and descriptions thereof).

It should be noted that the above description of the processing engine 112 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, the determination module 402, the detection module 406, the fitting module 404, and the calculation module 408 in the processing engine 112 may include at least one of a central processor (CPU), a digital signal processor (DSP), a microcontroller (MCU), or an electronic component having the same function. In some embodiments, one or more modules may be added or omitted. For example, a storage module may be added in the processing engine 112. In some embodiments, one or more modules may be combined into a single module. For example, the determination module 402 and the calculation module 408 may be combined into a single module.

FIG. 5 is a flowchart illustrating an exemplary process for transport pricing according to some embodiments of the present disclosure. In some embodiments, the process 500 may be implemented in the online to offline system 100. For example, the process 500 may be stored in the storage device 150 and/or the storage (e.g., the ROM 230, the RAM 240, etc.) as a form of instructions, and invoked and/or executed by the server 110 (e.g., the processing engine 112 in the server 110, or the processor 210 of the processing engine 112 in the server 110).

In 502, the processing engine 112 may determine an actual service cost and a preset service cost of each of historical orders, and an actual order count corresponding to the preset service cost.

In some embodiments, a historical order may be also referred to as a historical request for an online to offline service (i.e., a service request) that has been completed. For example, a service requestor may send a service request for an online to offline service (i.e., a service) to the online to offline system 100. A service provider may accept the service request and provide the service to the service requestor. The service requestor may pay the actual service cost for the service, indicating that the service request has been completed. The online to offline system 100 may save this service request as a historical service order into a storage device (e.g., the storage device 150). In some embodiments, the online to offline service may include a transportation service, such as a taxi service, a carpooling service, a hitch service, a delivery service, or the like, or any combination thereof. Take a transportation service as an example, a historical order may include a start location, a destination, a start time, a travel distance, or the like. The start location may refer to a location where a service requestor starts his/her journey or a service provider can pick up the service requestor. The destination may refer to a location where the service requestor ends his/her journey. The travel distance may refer to an actual distance that the service requestor travels from the start location to the destination.

In some embodiments, the historical orders may be generated during a historical time period before the present moment. For example, the historical time period may be one or more days, one or more weeks, one or more months, one or more quarters, one or more years, etc., before the present moment. As another example, the historical time period may be 1, 5, 10, 20, 30, or 60 minutes before the present moment. As a further example, the historical time period may be 8:00˜11:00, 11:00˜14:00, 14:00˜17:00, 17:00˜19:00, etc., yesterday.

As used herein, “a preset service cost of an order” may refer to an estimated cost of the order that a service requestor needs to pay for a service the service requestor requests. The preset service cost may be determined by the online to offline system 100 based on a preset pricing rule after the service requestor inputs travel information via a user interface associated an online to offline platform. For example, the preset pricing rule may be defined by one or more pricing parameters, e.g., an estimated starting distance, a cost for the estimated starting distance, a unit price of distances excluding the estimated starting distance. The processing engine 112 may determine the preset service cost of a historical order based on information of the historical order (e.g., a start location, a destination, a start time, an estimated travel distance) and the one or more pricing parameters. In some embodiments, at least a portion of the historical orders may correspond to a same preset service cost. In some embodiments, the historical orders may correspond to a plurality of preset service costs. Each of the plurality of preset service costs may correspond to one or more historical orders. “An actual service cost of an order” may refer to an actual cost of the order that a service requestor needs to pay for a service the service requestor requests after the order is completed. In some embodiments, the actual service cost of the order may be determined based on a preset pricing rule, actual travel information (e.g., an actual travel distance), or other special offers, etc. For example, the processing engine 112 may determine the actual service cost of the historical order by using one or more coupons. In some embodiments, the actual service cost of an order may be different from the preset service cost of the order. For example, the processing engine 112 may determine the actual service cost of the historical order by subtracting the coupons from the preset service cost. As another example, an estimated travel distance may be different with an actual travel distance. In some embodiments, the processing engine 112 may determine the actual service cost by performing a dynamic price adjustment on the preset service cost. For example, if the user initiates the order in peak hours, the processing engine 112 may determine the actual service cost by adding a fee relating to peak-hours to the preset service cost. “An actual order count corresponding to the preset service cost” may refer to the number of orders which have been completed and correspond to a same preset service cost among the historical orders. The processing engine 112 may statistically, determine the actual order count corresponding to the preset service cost based on the preset service costs of the historical orders.

In some embodiments, for a specific preset service cost, the processing engine 112 may determine the actual order count corresponding to the specific preset service cost by detecting whether a client terminal (e.g., the requestor terminal 130) associated with a service requestor (e.g., a passenger) initiates the historical order associated with the specific preset service cost and a client terminal (e.g., the provider terminal 140) associated with a service provider (e.g., a driver) accepts the historical order associated with the specific preset service cost. In response to a determination that the client terminal associated with the service requestor (e.g., the passenger) initiates the historical order associated with the specific preset service cost and the client terminal associated with the service provider (e.g., the driver) accepts the historical order associated with the specific preset service cost, the processing engine 112 may add one to the actual order count corresponding to the specific preset service cost.

In 504, the processing engine 112 may determine, based on the actual service cost of each of the historical orders, a total turnover.

As used herein, “a total turnover” of a platform (e.g., an online to offline platform) may refer to a total revenue of the platform during a time period, also referred to as a gross merchandise volume (GMV). In some embodiments, the processing engine 112 may determine a sum of the actual service cost of the each of the historical orders as the total turnover.

In 506, the processing engine 112 may determine a fitting function with a total turnover as a dependent variable, and a conversion rate and a price adjustment ratio as independent variables. A conversion rate may be associated with a preset service cost of an order. A specific conversion rate associated with a specific preset service cost may indicate a probability that a service request associated with the order having the specific service cost may be completed or the service request may be converted into the order. The conversation rate may be also referred to as an order formation conversation rate. The conversion rate corresponding to a specific preset service cost may be determined based on a ratio of the actual order count and an estimated order count corresponding to the specific preset service cost. As used herein, an estimated order count corresponding to a preset service cost may refer to an estimated number of orders having the preset service cost. Each of the historical orders may correspond to a preset service cost, which may correspond to a conversion rate. The price adjustment ratio may refer to a ratio of the actual service cost and the preset service cost. Each of the historical orders may correspond to a price adjustment ratio. In some embodiments, the processing device 112 may determine multiple conversation rates corresponding to the historical orders. Each of the multiple conversation rates may be determined based on a ratio of the actual order count and an estimated order count corresponding to a preset service cost of one of the historical orders. The estimated order count corresponding to a preset service cost may be determined according to a default setting of the online to offline system 100. Then the processing engine 112 may determine multiple adjustment ratios, each of which corresponds to a preset service cost and one of the historical orders. Each of the historical orders may correspond to a conversation rate and a price adjustment ratio. Then the processing engine 112 may determine the fitting function between a conversation rate, a price adjustment ratio, and a total turnover based on the total turnover determined in 504, the determined multiple conversation rates, and the determined multiple price adjustment ratios using a fitting technique applying machine learning model. The machine learning model may include a time series model, a linear regression model, a naive Bayesian model, a gradient boosting decision tree (GBDT) model, an extreme gradient boosting (XGBOOST) model, or the like, or a combination thereof.

In some embodiments, the processing engine 112 may determine the fitting function with a total turnover as a dependent variable, and a conversion rate and a price adjustment ratio as independent variables based on a relationship between the price adjustment ratio and the conversation rate (i.e., a first corresponding relationship), a relationship between a preset service cost and a demand ratio (i.e., a second corresponding relationship), and/or a distribution function of an actual demand amount. In some embodiments, the processing engine 112 may determine the relationship (i.e., the first corresponding relationship) between the price adjustment ratio and the conversation rate based on the historical orders. For example, the processing engine 112 may determine a demand conversation rate corresponding to each of the historical orders. As used herein, the demand conversation rate corresponding to an order may refer to a possibility that a service requestor will initiate a service request associated with the order when the service requestor knows and/or sees the price adjustment ratio. For example, when a service requestor wants to request a service via an online to offline platform associated with a client terminal (e.g., the requestor terminal 130). The service requestor may open the online to offline platform and input information associated with the service (e.g., a starting point, a destination, etc.). A server (e.g., the server 110) may determine a preset service cost and a price adjustment ratio for the service based on the information associated with the service and display the price adjustment ratio for the service to the service requestor. The service requestor may initiate or give up to initiate a service request for the service when the service requestor knows and/or sees the price adjustment ratio. The demand conversation rate corresponding to an order may be determined according to a default setting of the online to offline system 100. Then the processing engine 112 may determine a relationship between the demand conversation rate and the conversion rate (i.e., order formation conversation rate) based on the multiple demand conversation rates and corresponding price adjustment ratios. The processing engine 112 may determine the first corresponding relationship between the price adjustment ratio and the conversation rate based on the relationship between the demand conversation rate and the conversion rate (i.e., order formation conversation rate), in which the demand conversation rate may be denoted by the price adjustment ratio.

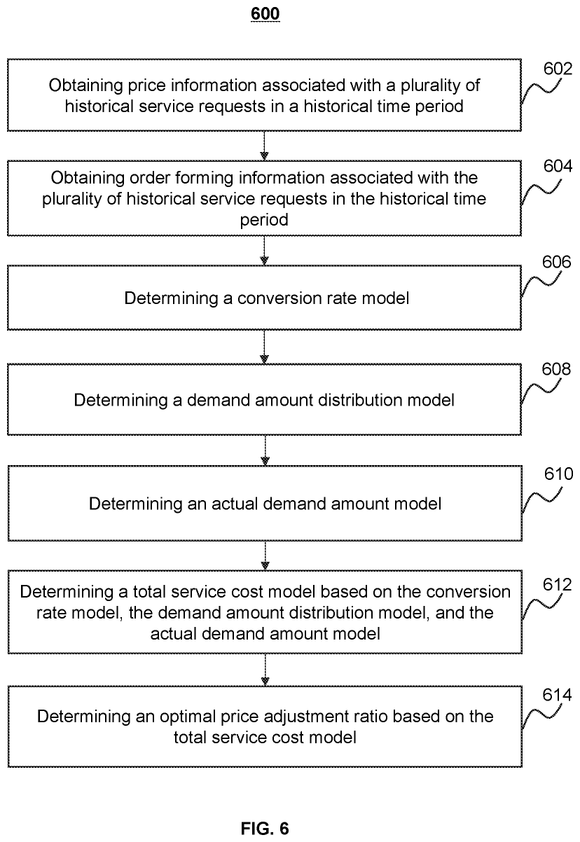

In some embodiments, for each of the historical orders, the processing engine 112 may detect whether a client terminal (e.g., the requestor terminal 130) associated with a service requestor (e.g., a passenger) confirms the receipt of the price adjustment ratio and initiates the each of the historical orders to determine a demand conversation rate for each of the historical orders. The processing engine 112 may detect whether a client terminal (e.g., the provider terminal 140) associated with a service provider (e.g., a driver) confirms the receipt of the price adjustment ratio and the each of the historical orders to determine the conversion rate (i.e., the order formation conversation rate) for each of the historical orders. The processing engine 112 may fit the demand conversation rate and the conversion rate (i.e., the order formation conversation rate) corresponding to each of the historical orders to determine the first corresponding relationship between the price adjustment ratio and the conversion rate (e.g., a conversion rate model P(mᵢ,r) as described in FIG. 6).

In some embodiments, by determining the demand conversation rate, the corresponding conversion rate, and the first corresponding relationship between the price adjustment ratio and the conversion rate, the accuracy of conversion rate determination corresponding to the price adjustment ratio may be improved. The relationship between the price adjustment ratio and the conversion rate may be determined by using a fitting technique. Accordingly, the accuracy of the determination of the first corresponding relationship between the price adjustment ratio and the conversion rate (e.g., the conversion rate model) may be improved, which may improve the accuracy of determining the conversion rate and the total turnover.

In some embodiments, the processing engine 112 may determine the relationship between a preset service cost and a demand ratio (i.e., the second corresponding relationship) based on the historical orders. For example, the processing engine 112 may determine the preset service cost, a preset demand amount, and an actual demand amount corresponding to the preset service cost. As used herein, the preset demand amount corresponding to a preset service cost may refer to an estimated count (or number) of service requests corresponding to the preset service cost that service requestors will initiate during a time period. The service requests along to the preset demand amount corresponding to the preset service cost may be completed or nor completed. As used herein, the actual demand amount corresponding to a preset service cost may refer to an actual count (or number) of service requests that service requestors have initiated during the time period. The service requests along to the actual demand amount corresponding to the preset service cost may be completed or nor completed. The processing engine 112 may determine a ratio between the preset demand amount and the actual demand amount corresponding to each of the preset service cost. The processing engine 112 may fit the preset service cost and the ratio between the preset demand amount and the actual demand amount correspond to the preset service cost based on the determined ratio between the preset demand amount and the actual demand amount corresponding to each of the preset service cost to determine the second corresponding relationship (e.g., a demand amount distribution model Q(m) as described in FIG. 6).

In some embodiments, by determining the ratio of the preset demand amount and the actual demand amount, and the second corresponding relationship between the preset service cost and the ratio of the preset demand amount and the actual demand amount using the fitting technique, the accuracy of the determination of the second corresponding relationship (e.g., the demand amount model) may be improved. That is, the ratio of the preset demand amount and the actual demand amount may be increased by adjusting the preset service cost, the accuracy and the rationality of determining the total turnover of the transport platform may further be improved.

In some embodiments, the processing engine 112 may determine, based on an operation time corresponding to each of the historical orders, the distribution function of the actual demand amount with respect to a specific time period (e.g., an actual demand amount model \hat{N}(t) as described in FIG. 6). The specific time period may include a plurality of sub-time periods. The distribution function of the actual demand amount may be used to indicate actual demand amounts during different sub-time periods. In some embodiments, the sub-time period may be any time period in a day, a week, a month, or a year. For example, the sub-time period may be 7:00 am˜8:00 am every day. In some embodiments, the sub-time period may be a day, a week, a month, a year, etc. For example, the sub-time period may be Monday, Tuesday, Wednesday, Thursday, Friday, Saturday, Sunday, etc.

In some embodiments, the first corresponding relationship, the second corresponding relationship, and/or the distribution function of the actual demand amount with respect to specific time periods may be established using a time series model, a linear regression model, a naive Bayesian model, a gradient boosting decision tree (GBDT) model, an extreme gradient boosting (XGBOOST) model, or the like.

In some embodiments, for the transport platform where the supply and the demand are balanced, the relationship between the supply and the demand in different time periods may be different. For example, the capacity demand during peak hours of commuting may be larger than the capacity supply, that is, the capacity may be tight. The capacity may be relatively less tight during other time periods. Therefore, by determining the distribution function of the actual demand amount with respect to the specific time period based on the operation time corresponding to the each of the historical orders, the real-time feature and the accuracy of the actual demand amount may be improved, which may be beneficial to optimize the transport pricing strategy under different operation times. Therefore, the total turnover and the competitiveness of the transport platform may further be improved.

In some embodiments, the processing engine 112 may determine the fitting function with the total turnover as the dependent variable and the conversion rate and price adjustment ratio as the independent variable based on the first corresponding relationship, the second corresponding relationship, and the distribution function of the actual demand amount. In some embodiments, the processing engine 112 may determine a product between the first corresponding relationship, the second corresponding relationship, the preset service cost, and the price adjustment ratio with respect to the specific time period. The processing engine 112 may then determine an accumulation of the product when the preset service cost satisfies a discrete distribution. The processing engine 112 may multiply the accumulation and the distribution function of the actual demand amount to determine the total turnover.

For example, after determining the first correspondent relationship and the second correspondent relationship according to the fitting technique, when the preset service cost satisfies the discrete distribution, the total turnover may be determined according to Equation (1):

GMV(r)=\hat{N}(t)×Σᵢ₌₁^{M}P(mᵢ,r)×mᵢ×r×Q(mᵢ), (1)

where GMV (r) refers to the total turnover; r refers to the price adjustment ratio; \hat{N}(t) refers to the distribution function of the actual demand amount with respect to a specific time period (also referred to as the actual demand amount model as described in FIG. 6); P(mᵢ,r) refers to a function of the first corresponding relationship (also referred to as the conversion rate model as described in FIG. 6); mᵢ refers to iₜₕ preset service cost in the discrete distribution of the preset service cost; M refers to the number of the preset service costs in the discrete distribution of the preset service cost, and a sample set of the preset service cost may be presented as {m₁, m₂, m₃ . . . mₘ}; and Q(mᵢ) refers to a function of the second corresponding relationship (also referred to as the demand amount distribution model as described in FIG. 6). In some embodiments, the processing engine 112 may determine a plurality of total turnovers based on the plurality of preset service costs in the sample set according to Equation (1). The processing engine 112 may determine the preset service cost in the sample set corresponding to a greatest total turnover.

In some embodiments, by determining the product between the first corresponding relationship, the second corresponding relationship, the preset service cost, and the price adjustment ratio with respect to the specific time period, the preset service cost may be determined. When the preset service cost satisfies the discrete distribution, the accumulation of the product may be determined. The accumulation and the distribution function of the actual quantity may be multiplied to determine the total turnover. The accuracy and the rationality of determining the total turnover of the transport platform may be improved.

In some embodiments, the processing engine 112 may determine the product between the first corresponding relationship, the second corresponding relationship, the preset service cost, and the price adjustment ratio with respect to the specific time period. The processing engine 112 may perform an integral operation on the product when the preset service cost satisfies a continuous distribution. The processing engine 112 may multiply an integral result and the distribution function of the actual demand amount to determine the total turnover, wherein a maximum of the preset service cost an integral range of the integral operation ≥0.

For example, after determining the first corresponding relationship and the second corresponding relationship according to the fitting technique, when the preset service cost satisfies the continuous distribution, the total turnover may be determined according to Equation (2):

GMV(r)=\hat{N}(t)×∫₀^{m}^{ₘₐₓ}P(m,r)×m×r×Q(m)dm, (2)

where, GMV (r) refers to the total turnover; r refers to the price adjustment ratio; \hat{N}(t) refers to the distribution function of the actual demand amount with respect to a specific time period (also referred to as the actual demand amount model as described in FIG. 6); P(m,r) refers to the function of the first corresponding relationship (also referred to as a conversion rate model as described in FIG. 6); m refers to the preset service cost; mₘₐₓ refers to a greatest preset service cost; and Q(m) refers to the function of the second corresponding relationship (also referred to as a demand amount distribution model as described in FIG. 6). In some embodiments, the processing engine 112 may determine a plurality of total turnovers based on the plurality of preset service costs according to Equation (2). The processing engine 112 may determine a preset service cost corresponding to a greatest total turnover.

In some embodiments, by determining the product between the first corresponding relationship, the second corresponding relationship, the preset service cost, and the price adjustment ratio with respect to the specific time period, the preset service cost may be determined. When the preset service cost satisfies the continuous distribution, the integral operation may be performed on the product. The integral result and the distribution function of the actual quantity may be multiplied to determine the total turnover. The accuracy and the rationality of determining the total turnover of the transport platform may be improved.

In 508, the processing engine 112 may obtain a plurality of orders provided by an online to offline platform during a current time period. Each of the plurality of orders may correspond to a preset service cost.

In 510, the processing engine 112 may determine a price adjustment ratio for each of the plurality of orders based on the determined fitting function with a total turnover as a dependent variable, and a conversion rate and a price adjustment ratio as independent variables. The processing engine 112 may input the preset service cost corresponding to each of the plurality of orders into the fitting function determined in operation 506. The processing engine 112 may determine the price adjustment ratio for each of the plurality of orders based on the fitting function. For example, the processing engine 112 may determine the price adjustment ratio for each of the plurality of orders which may cause the total turnover to exceed a threshold. As another example, the processing engine 112 may determine the price adjustment ratio for each of the plurality of orders which may cause the total turnover to be maximum locally or globally. In some embodiments, the price adjustment ratio for each of the plurality of orders may be same. In some embodiments, the price adjustment ratio for each of the plurality of orders may be different.

In 512, the processing engine 112 may adjust the preset service cost for each of at least a portion of the plurality of orders based on the price adjustment ratio. For example, the processing engine 112 may multiply the price adjustment ratio and the preset service cost corresponding to a specific order to determine an adjusted present service cost for the specific order.

According to process 500, the accuracy of determining the price adjustment ratio of each of the historical orders may be improved by referring to the actual service cost, the preset service cost, and the actual order count of the each of the historical orders. By determining the fitting function with the conversion rate and the price adjustment ratio as the independent variables, and the total turnover as the dependent variable, the conversion rate and the price adjustment ratio may be two main factors for determining the total turnover, rather than a relationship between supply and demand. The total turnover of a transport platform (e.g., a taxi service platform) where the supply and the demand are balanced may be increased.

According to process 500, the fitting function of the total turnover, the preset service cost, and the price adjustment ratio may be determined based on a relationship between the actual service cost, the preset service cost, and the actual order count. The accuracy of the total turnover determination based on the preset service cost and price adjustment ratio may be improved. The accuracy and the rationality of the preset service cost and the price adjustment ratio may be improved. Therefore, the competitiveness of the transport platform may further be improved.

According to process 500, the preset service cost and the price adjustment ratio may be determined based on a preset total turnover. Since the price adjustment ratio is determined by comprehensively considering the willingness of a passenger to initiate an order and the willingness of a driver to accept the order, the accuracy of determining the price adjustment ratio may be effectively improved. Therefore, the market share and the total turnover of a transport platform may be improved.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure.

FIG. 6 is a flowchart illustrating an exemplary process for optimizing a total turnover according to some embodiments of the present disclosure. In some embodiments, the process 600 may be implemented in the online to offline system 100. For example, the process 600 may be stored in the storage device 150 and/or the storage (e.g., the ROM 230, the RAM 240, etc.) as a form of instructions, and invoked and/or executed by the server 110 (e.g., the processing engine 112 in the server 110, or the processor 210 of the processing engine 112 in the server 110).

In 602, the processing engine 112 may obtain price information associated with a plurality of historical service requests in a historical time period.

Each of the plurality of historical service requests may have been completed or uncompleted. For example, a service requestor may send a service request for a service (e.g., a transportation service) to a server (e.g., the server 110) associated with an online to offline platform via a client terminal associated with the online to offline platform (e.g., a requestor terminal 130). A service provider may accept the service request via a client terminal associated with the online to offline platform (e.g., a provider terminal 140) and provide the service to the service requestor, indicating that the service request has been completed, or the service requestor may cancel the service request, indicating that the service request has been uncompleted. In some embodiments, the price information associated with a historical service request may include a preset service cost of the service request, an actual service cost of the historical service request, a preset adjustment ratio, an actual price adjustment ratio of the historical service request, or the like, or any combination thereof. In some embodiments, the processing engine 112 may obtain the price information associated with each of the historical orders from the storage device 150, the storage 390, or any other storage device as described elsewhere in the present disclosure. For example, the processing engine 112 may obtain the preset service cost m for a historical service request generated after a user inputted a start location and a destination associated with the each of the historical service requests. As another example, the processing engine 112 may obtain the actual service cost \hat{m} of a historical service request generated based on one or more coupons and/or a dynamic price adjustment on the preset service cost of the each of the historical orders after the each of the historical service requests has been completed. In some embodiments, the processing engine 112 may determine the actual price adjustment ratio r (e.g., r=\hat{m}/m) of the each of the historical orders based on the preset service cost m of the each of the historical orders and the actual service cost \hat{m} of the each of the historical orders.

In 604, the processing engine 112 may obtain order forming information associated with the plurality of historical service requests in the historical time period. As used herein, the term “order forming” may refer to that a historical service request is converted into and/or form an order after the historical service request has been completed. For example, a historical service request may be initiated by a service requestor after the service requestor receives a preset service cost. The initiated historical service request may be received by a service provider, and the service provider may provide a service to the service requestor. The service requestor may pay an actual service cost for the service after the service is finished. Then the historical service request may be converted into and/or form an order.

In some embodiments, the order forming information may include whether a service requestor (e.g., a passenger) initiates a historical service request after a price estimation, whether a service provider (e.g., a driver) accepts the historical service request, and whether the service requestor (e.g., the passenger) pays the historical service request after the historical service request is completed.

In 606, the processing engine 112 may determine a conversion rate model.

In some embodiments, the processing engine 112 may determine the conversion rate model based on the preset service cost, the actual price adjustment ratio, and the order forming information associated with each of the plurality of historical service requests. The conversion rate model may be used to estimate and/or determine a conversation rate (i.e., an order forming conversation rate) corresponding to a specific service request. The conversation rate corresponding to a specific service request may refer to a probability that a service provider (e.g., a driver) accepts the specific service request and an order corresponding to the specific service request is formed after a service requestor is willing to initiate the specific service request when knowing a preset service cost and a price adjustment ratio corresponding to the specific service request. In some embodiments, the conversion rate model may be determined by using a linear regression model, a naive Bayesian model, a GBDT model, a XGBOOST model, or the like. For example, the conversation rate model may be obtained and/or trained by fitting a relationship between a preset service cost, a price adjustment ratio, and a conversation rate based on the preset service cost, the actual price adjustment ratio, and the order forming information associated with each of the plurality of historical service requests using for example, a linear regression model, a naive Bayesian model, a GBDT model, a XGBOOST model, etc. As a further example, the processing engine 112 may determine multiple conversation rates corresponding to multiple preset service costs and actual price adjustment ratios corresponding to each of the plurality of service requests. Each of the multiple conversation rates may be determined based on a ratio of an estimated order count and an actual order count. The actual order count corresponding to a preset service cost and a price adjustment ratio may be statistically, determined based on the order forming information associated with each of the plurality of historical. The estimated order count may be determined according to a default setting of the online to offline system 100. The processing engine 112 may determine the conversation rate model by fitting a relationship between the conversation rate, the price adjustment ratio, and/or the preset service cost based on the determined conversation rates and the corresponding preset service costs and price adjustment ratios.

The conversation rate model may be configured to provide the relationship between a preset service cost, a price adjustment ratio, and a conversation rate. The conversation rate model may be configured to determine and/or output a conversation rate corresponding to a specific service request based on the relationship.

In 608, the processing engine 112 may determine a demand amount distribution model.

The demand amount distribution model may be used to determine a demand proportion under a specified preset service cost. As used herein, a demand proportion under a specified preset service cost may refer to a ratio of an estimated demand amount and an actual demand amount corresponding to the specified preset service cost. The demand amount distribution model may be also referred to as a demand proportion model. In some embodiments, the processing engine 112 may determine the demand amount distribution model Q(m) based on the preset service cost, a preset demand amount, and an actual demand amount corresponding to the preset service cost. As used herein, a demand amount may be defined by a count or number of service requests in a time period. In some embodiments, the processing engine 112 may statistically, determine the actual demand amount of service requests corresponding to a same preset service cost among the plurality of historical service requests. The processing engine 112 may obtain the preset demand amount corresponding to the same preset service cost from the storage device 150, the storage 390, or any other storage device, which may be a default setting of the online to offline system 100. The processing engine 112 may determine a demand proportion based on the preset demand amount and the actual demand amount corresponding to the same preset service cost. The processing engine 112 may determine the demand amount distribution model by fitting a relationship between a demand proportion and a preset service cost based on the determined demand proportion and the same preset service cost corresponding to the plurality of historical service requests using a fitting model. The processing engine 112 may determine a specified demand proportion based on a specified preset service cost using the demand amount distribution model. Exemplary fitting models may include a linear regression model, a naive Bayesian model, a GBDT model, an XGBoost model, or the like.

In 610, the processing engine 112 may determine an actual demand amount model. The actual demand amount model may be used to predict a change of the demand amount in a future time period.

The processing engine 112 may determine the actual demand amount model \hat{N}(t) based on actual demand amounts in each sub-time periods of the historical time period. For example, if the historical time period includes one week, the sub-time periods of the historical time period may include each day in the one week. As another example, if the historical time period includes one day, the sub-time periods of the historical time period may include 7:00-11:00, 11:00-14:00, 14:00-16:00, 16:00-19:00, etc. In some embodiments, the processing engine 112 may statistically, determine the actual demand amount of service requests corresponding to each sub-time periods of the historical time period among the plurality of historical service requests. The processing engine 112 may determine the actual demand amount model by fitting a relationship between an actual demand amount and a sub-time period based on the determined demand amounts using a fitting model. The actual demand amount model may be used to determine whether it is applicable to a total turnover optimal algorithm. Exemplary fitting models may include a time series model, an XGBoost model, a GBDT model, a linear regression model, a neural network model, or the like.

In 612, the processing engine 112 may determine a total turnover model based on the conversion rate model, the demand amount distribution model, and the actual demand amount model. The total turnover model may be configured to provide a function relationship (i.e., the fitting function as described in FIG. 5) between a total turnover, a preset service cost and a price adjustment ratio. The total turnover model may be used to determine a total turnover in a specific time period (e.g., a future time period) based on preset service costs and price adjustment ratio of service requests generated in the specific time period.

The processing engine 112 may determine the total turnover model with respect to different price adjustment ratios based on the conversion rate model, the demand amount distribution model, and the actual demand amount model. In some embodiments, when a preset service cost satisfies a discrete distribution, the total turnover model may be determined according to Equation (1) as described elsewhere in the present disclosure (e.g., FIG. 5 and descriptions thereof). In some embodiments, when the preset service cost satisfies a continuous distribution, the total turnover model may be determined according to Equation (2) as described elsewhere in the present disclosure (e.g., FIG. 5 and descriptions thereof). As used herein, the discrete distribution of a preset service cost may refer to that the preset service cost is determined based on different distance ranges. Different distance ranges may correspond to different service costs. For example, a preset service cost may be determined based on a starting distance, a cost for the starting distance, and a unit price of distances excluding the starting distance. The continuous distribution of a preset service cost may refer to that the preset service cost is changed with a distance continuously. For example, a preset service cost may be determined based on a unit price of distance and a total distance.

In 614, the processing engine 112 may determine an optimal price adjustment ratio based on the total turnover model.

In some embodiments, the processing engine 112 may obtain a plurality of service requests in a future time period. Each of the plurality of service requests may correspond to a preset service cost. The processing engine 112 may input the preset service cost corresponding to the each of the plurality of service requests into the total turnover model. The processing engine 112 may determine the optimal price adjustment ratio based on the total turnover model using an optimal solution algorithm. Exemplary optimal solution algorithms may include a gradient descent algorithm, a genetic algorithm, a particle swarm algorithm, a simulated annealing algorithm, or the like.

For example, the processing engine 112 may perform an automatically searching operation when a total turnover corresponding to the plurality of service requests satisfies a condition, for example, exceeds a threshold, or be maximum locally or globally (i.e. optimal). As a further example, when the preset service cost satisfies the discrete distribution, the optimal price adjustment ratio of the each of the plurality of service requests may be determined according to Equation (3):

r*=argmaxGMV(r)=argmax\hat{N}(t)×Σᵢ₌₁^{M}p(mᵢ,r)×mᵢ×r×Q(mᵢ), (3)

where GMV (r) refers to the total turnover; r refers to the price adjustment ratio; \hat{N}(t) refers to the actual demand amount model; P(mᵢ,r) refers to the conversion rate model; mᵢ refers to iₜₕ preset service cost in the discrete distribution of the preset service cost; M refers to the number of the preset service costs in the discrete distribution of the preset service cost; Q(mᵢ) refers to the demand amount distribution model; and r* refers to the optimal price adjustment ratio corresponding to the optimal total turnover. If r* is greater than 1, it may indicate that the total turnover may be optimized by increasing the preset service cost in a future time period. If r* is less than 1, it may indicate that the total turnover may be optimized by decreasing the preset service cost in the future time period. If r* is equal to 1, it may indicate that the total turnover is optimal, and the preset service cost may not need to be adjusted. In some embodiments, each of the plurality of service requests may correspond to the same optimal price adjustment ratio. In some embodiments, different service requests may correspond to different optimal price adjustment ratios.

In some embodiments, the processing engine 112 may adjust the preset service cost based on the optimal price adjustment ratio. For example, assuming that the preset service cost (e.g., a starting price, a mileage fee) is m, the processing engine 112 may determine that the adjusted service cost (e.g., an adjusted starting price, an adjusted mileage fee) is m′(m′=r**m).

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure.

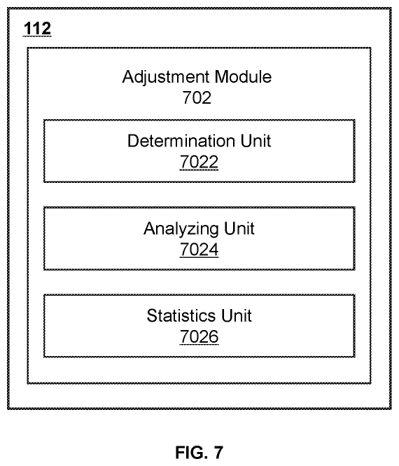

FIG. 7 is a block diagram illustrating an exemplary processing engine according to some embodiments of the present disclosure. In some embodiments, the processing engine 112 may include an adjustment module 702. The adjustment module 702 may include a determination unit 7022, an analyzing unit 7024, and a statistics unit 7026. The modules and/or the units may be hardware circuits of at least part of the processing engine 112. The modules and/or the units may also be implemented as an application or set of instructions read and executed by the processing engine 112. Further, the modules and/or the units may be any combination of the hardware circuits and the application/instructions. For example, the modules and/or the units may be part of the processing engine 112 when the processing engine 112 is executing the application or set of instructions.

The adjustment module 702 may be configured to adjust an estimated service cost associated with an order. For example, in response to information of a plurality of orders in a specific time period, the adjustment module 702 may determine and/or adjust, based on a preset constraint between a total turnover and a service cost, an estimated service cost associated with each of at least a portion of the plurality of orders.

The determination unit 7022 may be configured to determine, based on a preset constraint, a range of an estimated service cost associated with the each of at least a portion of a plurality of orders when an estimated total turnover exceeds a preset total turnover and/or an estimated order count exceeds a preset order count in a specific time period. The determination unit 7022 may be configured to determine a mapping relationship between a travel distance and an estimated order count associated with historical orders. The determination unit 7022 may be configured to determine, based on a service cost of each of historical orders, a historical starting distance of each of the historical orders, a cost for the historical starting distance of each of the historical orders, and an unit price of distances excluding the corresponding historical starting distance of each of the historical orders, a conversion rate, and a mapping relationship between a travel distance and an estimated order count associated with the historical orders, a preset constraint.

The analyzing unit 7024 may be configured to analyze, corresponding to a service cost of each of historical orders, a historical starting distance of each of the historical orders, a cost for the historical starting distance of each of the historical orders, and a unit price of distances excluding the corresponding historical starting distance of each of the historical orders.

The statistics unit 7026 may be configured to determine statistically, a relationship between a service cost and a conversion rate associated with historical orders.

In some embodiments, by adjusting, based on the preset constraint between the total turnover and the service cost, the estimated service cost associated with the each of at least a portion of the plurality of orders, the accuracy of transport pricing may be improved, which may be beneficial to increasing the driver's willingness to accept the order. The total turnover of a transport platform may be improved, while the order count may not be reduced. The competitiveness and the market occupancy of the transport platform may be improved.

In some embodiments, after determining the preset constraint, on one hand, the preset constraint may also be determined based on the preset total turnover. The range of the estimated service cost associated with the each of at least a portion of the plurality of orders may further be determined. The estimated service cost may be determined based on the estimated starting distance, the cost for the estimated starting distance, the unit price of distances excluding the estimated starting distance, and the relationship between the estimated service cost and the estimated starting distance, the cost for the estimated starting distance, and the unit price of distances excluding the estimated starting distance. That is, by determining a range of at least one of the starting distance, the cost for the starting distance, and the unit price of distances excluding the starting distance, the total turnover may be improved. On the other hand, it is possible to consider the change of the estimated order count in the specified time period while determining the estimated service cost. The essence is to stimulate more order transactions. Therefore, it is conducive to further promoting the transport platform and expanding the market share.

In some embodiments, by determining, based on the service cost of each of historical orders, the historical starting distance of each of the historical orders, the cost for the historical starting distance of each of the historical orders, and the unit price of distances excluding the historical starting distance of each of the historical orders, the conversion rate, and the relationship between the travel distance and the estimated order count associated with the historical orders, the preset constraint, the effect of at least one of the service cost, the starting distance, the cost for the starting distance, and the unit price of distances excluding the starting distance on the total turnover may be determined separately or comprehensively by using the conversion rate as an intermediate variable. The range of at least one of the starting distance, the cost for the starting distance, and the unit price of distances excluding the starting distance may be determined based on an optimal output variable (e.g., the total turnover) of the constraint. Further, the range of at least one of the starting distance, the cost for the starting distance, and the unit price of distances excluding the starting distance may be determined based on the increase of the total turnover. For example, assuming that the increase of the total turnover is a % (a≥0), the starting distance, the cost for the starting distance, and the unit price of distances excluding the starting distance that satisfy the increase of the total turnover (e.g., a %) may be determined. The accuracy of determining the starting distance, the cost for the starting distance, and the unit price of distances excluding the starting distance may be improved. It is beneficial to increase the total transaction volume and market occupancy rate of the operating platform while satisfying the increase of total turnover.

Further, by adjusting the estimated service cost of the order, a reasonable conversion rate may be determined, which may improve the total order count and the total turnover.

The preset constraint may be a relationship between the total turnover and the service cost with the service cost as an input and the total turnover as an output. The preset constraint may be constructed based on a linear regression model, a naive Bayesian model, a gradient boost decision tree (GBDT) model, a XGBOOST model, or the like, or any combination thereof. The processing engine 112 may determine the total turnover based on a specific service cost and the preset constraint.

As used herein, the estimated order count may refer to the number of orders that service requestors have input order information via client terminals (e.g., the requestor terminals 130) but has not yet initiated or formed. For example, a passenger may input a start location, a destination, and a start time via a user interface of the requestor terminal 130, and the order has not been confirmed and initiated by the passenger. That is, a bubbling order may be generated. The estimated order count may be the number of all the bubbling orders.

In some embodiments, by determining the service cost of the historical order corresponding to the distance range, an estimated order count corresponding to the distance range, and the preset constraint, the total turnover of the historical order may be determined. The processing engine 112 may determine whether the adjusted service cost improves the total turnover of a transport platform based on the total turnover of the historical order. The accuracy of the determining whether the total turnover is improved may be improved, which may improve the rationality of the determination of the preset service cost.

It should be noted that the above description of the processing engine 112 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, the adjustment module 702, the determination unit 7022, the analyzing unit 7024, and the statistics unit 7026 in the processing engine 112 may include at least one of a central processor (CPU), a digital signal processor (DSP), a microcontroller (MCU), or an electronic component having the same function.

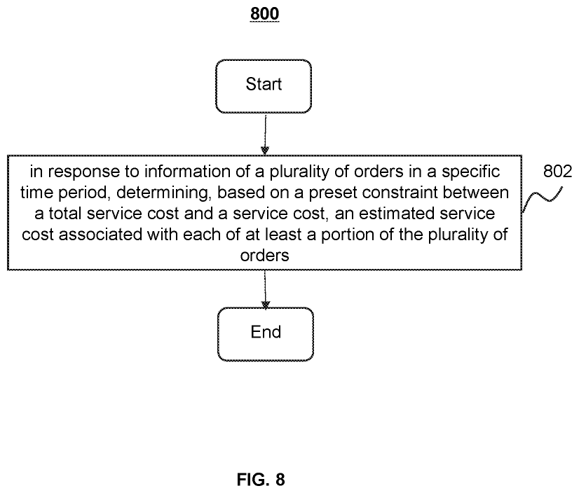

FIG. 8 is a flowchart illustrating an exemplary process for data processing according to some embodiments of the present disclosure. In some embodiments, the process 800 may be implemented in the online to offline system 100. For example, the process 800 may be stored in the storage device 150 and/or the storage (e.g., the ROM 230, the RAM 240, etc.) as a form of instructions, and invoked and/or executed by the server 110 (e.g., the processing engine 112 in the server 110, or the processor 210 of the processing engine 112 in the server 110).

In 802, in response to information of a plurality of orders in a specific time period, the processing engine 112 may determine and/or adjust, based on a preset constraint between a total turnover and a service cost, an estimated service cost associated with each of at least a portion of the plurality of orders.

In some embodiments, by adjusting, based on the preset constraint between the total turnover and the service cost, the estimated service cost associated with the each of at least a portion of the plurality of orders, the accuracy of transport pricing may be improved, which may be beneficial to increasing the driver's willingness to accept the order. The total turnover of a transport platform may be improved, while the order count may not be reduced. The competitiveness and the market occupancy of the transport platform may be improved.

In some embodiments, the specific time period may be a current time period with respect to the present moment. For example, the current time period may refer to a specific time range close to the present moment. As a further example, the specific time period may be 1 minute, 2 minutes, 3 minutes, 4 minutes, 5 minutes, 10 minutes, 20 minutes, 30 minutes, 60 minutes, etc., after and/or before the present moment. In some embodiments, the specific time period may be a future time period with respect to the present moment. For example, the specific time period may be 8:00 am-9:00 am tomorrow, tomorrow morning, tomorrow, the day after tomorrow, etc.

As used herein, an order may be also referred to as a service request. For example, a service requestor may send a service request for a service (e.g., a transportation service) to a server (e.g., the server 110) associated with an online to offline platform via a client terminal associated with the online to offline platform (e.g., a requestor terminal 130). The server may receive the service request. In some embodiments, the service request may have not been processed and/or dispatched by the server to a service provider. For example, the server may not determine a preset service cost for the service request. As another example, the server may have determined a preset service cost for the service request, while not display the preset service cost for the service requestor. In some embodiments, the service request may have been processed and/or dispatched by the server to a service provider. For example, the service provider may not accept the dispatched service request and the service request may be cancelled by the server. As another example, the service provider may accept the service request via a client terminal associated with the online to offline platform (e.g., a provider terminal 140) and provide the service to the service requestor, indicating that the service request has been completed.

In some embodiments, a service request may include a real-time request or an appointment request. As used herein, the real-time request may indicate that the service requestor wishes to use the service at the present moment or at a defined time reasonably close to the present moment for an ordinary person in the art. For example, a service request may be a real-time request if the defined time is shorter than a threshold value, such as 1 minute, 5 minutes, 10 minutes, 20 minutes, etc. The appointment request may indicate that the service requestor wishes to use the service (e.g., a transportation service) at a defined time which is reasonably far from the present moment for the ordinary person in the art. For example, a service request may be an appointment request if the defined time is longer than a threshold value, such as 20 minutes, 2 hours, or 1 day.

In some embodiments, the processing engine 112 may obtain the plurality of orders from the storage device 150, the client terminal (e.g., the requestor terminal 130, the provider terminal 140) of one or more users via the network 120. In some embodiments, the client terminal may establish a communication (e.g., a wireless communication) with the server 110, for example, through an application (e.g., the application 380 in FIG. 3) installed in the client terminal. In some embodiments, the application may be associated with a service platform (e.g., an online to offline service platform). For example, the application may be associated with a taxi-hailing service platform. In some embodiments, the service requestor may log into the application and initiate an order. In some embodiments, the application installed in the client terminal may direct the client terminal to monitor the order from the service requestor continuously or periodically, and automatically transmit the order to the processing engine 112 via the network 120.

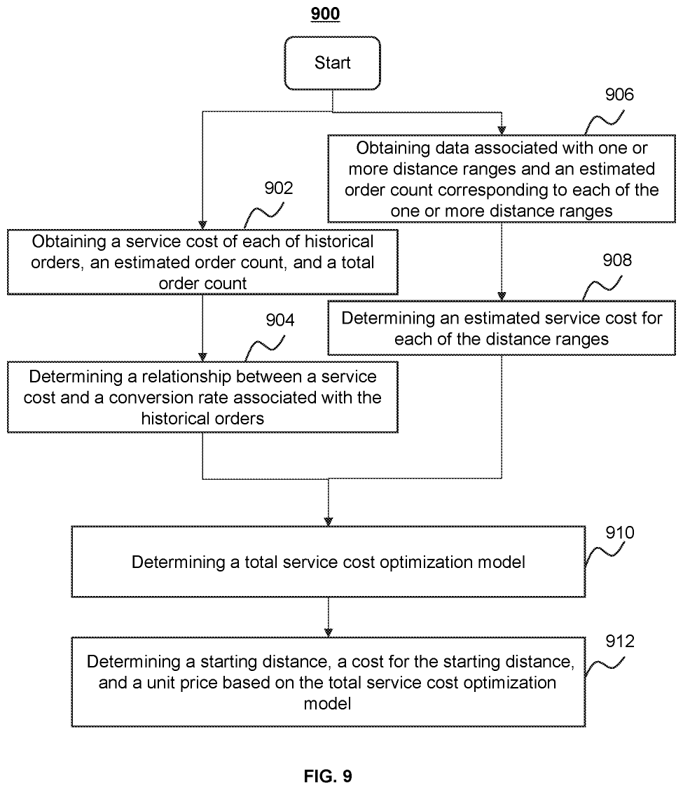

In some embodiments, each of the plurality of orders may correspond to an estimated service cost. The estimated service cost may be also referred to as a preset service cost. As used herein, “an (estimated) service cost of an order” may refer to an (estimated) revenue of the order. In some embodiments, the estimated service cost of an order may be determined according to a pricing rule. The pricing rule may be determined by a user or according to a default setting of the online to offline system 100. For example, the pricing rule may be determined according to a plurality of historical orders. The price rule may be associated with a travel distance. In some embodiments, the price rule may present a continuous distribution of a service cost in the travel distance. For example, the estimated service cost may be determined by multiplying the travel distance with a unit price per kilometer. In some embodiments, the price rule may present a discontinuous distribution (i.e., discrete distribution) of a service cost in the travel distance. For example, the travel distance may be divided into a few sections (e.g., an estimated starting distance, and distances excluding the estimated starting distance). The estimated service cost may have a fitting relationship with an estimated starting distance, a cost for the estimated starting distance, and a unit price of distances excluding the estimated starting distance. The fitting relationship may be determined based on a service cost of each of historical orders, a historical starting distance of each of the historical orders, a cost for the historical starting distance of each of the historical orders, and a unit price of distances excluding the corresponding historical starting distance of each of the historical orders. More descriptions of the determination of the estimated starting distance, an cost for the estimated starting distance, and a unit price of distances excluding the estimated starting distance may be found elsewhere in the present disclosure (e.g., FIG. 9 and descriptions thereof).

In some embodiments, the processing engine 112 may determine and/or adjust the estimated service cost associated with the each of the at least a portion of the plurality of orders based on the preset constraint between the total turnover and the service cost. As used herein, “a total turnover of a platform (e.g., an online to offline platform)” may refer to a total revenue of the platform in a specific time period. For example, the processing engine 112 may determine, based on the preset constraint, a range of the estimated service cost associated with the each of the at least a portion of the plurality of orders when an estimated total turnover of the plurality of orders satisfies a condition and/or an estimated total count of formation orders among the plurality of orders satisfies a condition. In some embodiments, the estimated total turnover of the plurality of orders satisfying the condition may include that the estimated total turnover exceeds a preset total turnover. The estimated total count of formation orders among the plurality of orders satisfying the condition may include the estimated total count of formation orders exceeds a preset order count in the specific time period. In some embodiments, the estimated total turnover of the plurality of orders satisfying the condition may include that an increase of the estimated total turnover after adjusting the estimated service cost exceeds a threshold. The estimated total count of formation orders among the plurality of orders satisfying the condition may include an increase of the estimated total count of formation orders after adjusting the estimated service cost exceeds a threshold. In some embodiments, the processing engine 112 may further adjust the estimated service cost based on the range of the estimated service cost to determine a target estimated service cost for each of the at least a portion of the plurality of orders. In some embodiments, the processing engine 112 may directly determine the target estimated service cost for each of the at least a portion of the plurality of orders when the estimated total turnover of the plurality of orders satisfies the condition and/or the estimated total count of formation orders among the plurality of orders satisfies the condition. As used herein, a formation order may refer to an order that has been completed after a service provider provides a service to a service requestor and the service requestor pays an actual service cost for the order.

In some embodiments, after determining the preset constraint, on one hand, the preset constraint may also be determined based on the preset total turnover. The range of the estimated service cost associated with the each of at least a portion of the plurality of orders may further be determined. The estimated service cost may be determined based on the estimated starting distance, the cost for the estimated starting distance, the unit price of distances excluding the estimated starting distance, and the relationship between the estimated service cost and the estimated starting distance, the cost for the estimated starting distance, and the unit price of distances excluding the estimated starting distance. That is, by determining a range of at least one of the starting distance, the cost for the starting distance, and the unit price of distances excluding the starting distance, the total turnover may be improved. On the other hand, it is possible to consider the change of the estimated order count in the specified time period while determining the estimated service cost. The essence is to stimulate more order transactions. Therefore, it is conducive to further promoting the transport platform and expanding the market share.

In some embodiments, the processing engine 112 may determine the preset constraint based on information of a plurality of historical orders. The plurality of historical orders may be provided by an online to offline platform in a historical time period. The historical time period may be a day, a week, a month, a quarter, etc., before the present moment or the specific time period as described above. In some embodiments, the processing engine 112 may determine the preset constraint based on a relationship between a conversion rate and a service cost, a mapping relationship between a travel distance and an estimated order count. In some embodiments, before responding to the plurality of orders in the specific time period, the processing engine 112 may analyze the historical starting distance of each of the historical orders, a cost for the historical starting distance of each of the historical orders, and the unit price of distances excluding the corresponding historical starting distance of each of the historical orders corresponding to the service cost of each of historical orders. The processing engine 112 may denote the service cost corresponding to each of the plurality of historical orders based on a starting distance of an order, a cost for the starting distance of the order, and the unit price of distances excluding the corresponding starting distance of the order and an estimated service cost of the order based on the analysis result.

The processing engine 112 may determine statistically, the relationship between a service cost and a conversion rate associated with the historical orders. The conversation rate may be used to reflect a probability that a service request has been completed. The conversation rate may be also referred to an order forming conversation rate. The processing engine 112 may denote the relationship between a service cost and a conversion rate as a conversation rate model. The conversation rate model may provide the relationship between a service cost and a conversion rate. The conversation model may be used to determine a specific conversation rate based on a specific service cost using the conversation model. Further, the specific conversion rate of a specific order may be determined based on an estimated service cost of the specific order and the relationship between the service cost and the conversion rate. In some embodiments, the processing engine 112 may fit the relationship between the service cost and the order forming conversion rate using a first machine learning model with the service cost as described in connection with operation 904. For example, each of the historical orders may correspond to a service cost. The processing engine 112 may statistically, determine an actual order count corresponding to a same service cost. The processing engine 112 may determine a conversation rate corresponding to the same service cost based on an actual order count corresponding to the same service cost and an estimated service cost corresponding to the same service cost. As used herein, the conversion rate corresponding to a service cost may refer to a ratio of a total order count to the estimated order count corresponding to a service cost. Similarly, the processing engine 112 may determine multiple groups of conversation rates and service costs based on the historical orders. Then the processing engine 112 may fit the relationship between a conversation rate and a service cost based on the determined multiple groups of conversation rates and service costs using the first machine learning model. As used herein, the estimated order count may refer to the number of orders that service requestors have input order information via client terminals (e.g., the requestor terminals 130) but has not yet initiated or formed. For example, a passenger may input a start location, a destination, and a start time via a user interface of the requestor terminal 130, and the order has not been confirmed and initiated by the passenger. That is, a bubbling order may be generated. The estimated order count may be the number of all the bubbling orders.

The processing engine 112 may determine the mapping relationship between a travel distance and an estimated order count based on the historical orders. For example, the processing engine 112 may determine the mapping relationship between the travel distance and the estimated order count by using a second machine learning model, as described in connection with operation 906. As a further example, each of the plurality of historical orders may correspond to a travel distance. The processing engine 112 may statistically, determine an order count corresponding to a same travel distance from the plurality of historical orders. Similarly, the processing engine 112 may determine multiple groups of order counts and travel distances. The processing engine 112 may fit the mapping relationship between a travel distance and an estimated order count using the second machine learning model based on the multiple groups of order counts and travel distances.

The first machine learning model and/or the second machine learning model may be constructed based on a linear regression model, a naive Bayesian model, a gradient boost decision tree (GBDT) model, a XGBOOST model, an artificial neural network, a support vector machine (SVM) model, a genetic model, or the like, or any combination thereof. The processing engine 112 may determine, based on the service cost of each of historical orders, the historical starting distance of each of the historical orders, the cost for the historical starting distance of each of the historical orders, and the unit price of distances excluding the corresponding historical starting distance of each of the historical orders, the conversion rate, and the mapping relationship between the travel distance and the estimated order count associated with the historical orders, the preset constraint.

In some embodiments, by determining, based on the service cost of each of historical orders, the historical starting distance of each of the historical orders, the cost for the historical starting distance of each of the historical orders, and the unit price of distances excluding the historical starting distance of each of the historical orders, the conversion rate, and the relationship between the travel distance and the estimated order count associated with the historical orders, the preset constraint, the effect of at least one of the service cost, the starting distance, the cost for the starting distance, and the unit price of distances excluding the starting distance on the total turnover may be determined separately or comprehensively by using the conversion rate as an intermediate variable. The range of at least one of the starting distance, the cost for the starting distance, and the unit price of distances excluding the starting distance may be determined based on an optimal output variable (e.g., the total turnover) of the constraint. Further, the range of at least one of the starting distance, the cost for the starting distance, and the unit price of distances excluding the starting distance may be determined based on the increase of the total turnover. For example, assuming that the increase of the total turnover is a % (a≥0), the starting distance, the cost for the starting distance, and the unit price of distances excluding the starting distance that satisfy the increase of the total turnover (e.g., a %) may be determined. The accuracy of determining the starting distance, the cost for the starting distance, and the unit price of distances excluding the starting distance may be improved. It is beneficial to increase the total transaction volume and market occupancy rate of the operating platform while satisfying the increase of total turnover.

Further, by adjusting the estimated service cost of the order, a reasonable conversion rate may be determined, which may improve the total order count and the total turnover.

In some embodiments, the preset constraint may be determined according to Equation (4):

GMV=Σ₁ⁿPᵢ(D)×Estcntᵢ(D)×Ratioᵢ(P(D)), (4)

where GMV refers to the total turnover; Pᵢ(D) refers to a service cost of iₜₕ historical order corresponding to a distance range; Estcntᵢ(D) refers to an estimated order count corresponding to a distance range; Ratioᵢ(P(D) refers to a conversion rate corresponding to the iₜₕ historical order; D refers to a service distance corresponding to the iₜₕ historical order, P(D) refers to a total turnover of the historical orders, and n refers to the total order count of the historical orders, n being an positive integer ≥1. The distance range may be a travel distance that is less than, equal to, or greater than the starting distance.

The preset constraint may be used to estimate and/or determine the total turnover associated with the each of at least a portion of the plurality of orders based on a starting distance, a service cost for the starting distance, and a unit price per kilometers for the distance excluding the starting distance determined in process 900. For example, the processing engine 112 may adjust the starting distance, the service cost for the starting distance, and the unit price per kilometers for the distance excluding the starting distance. The conversation rate may be changed as the adjusted service cost for the starting distance and the adjusted unit price per kilometers for the distance excluding the starting distance. The estimated order count may be changed as the adjusted starting distance. Then the total turnover associated with the each of at least a portion of the plurality of orders may be changed.

In some embodiments, the processing engine 112 may determine an optimal solution of the preset constraint when a condition is satisfied. The optimal solution of the preset constraint may be the starting distance, the service cost for the starting distance, and the unit price per kilometers for the distance excluding the starting distance. In some embodiments, the condition may be such that the total turnover corresponding to the optimal solution exceeds a threshold. In some embodiments, the condition may be such that the total order count corresponding to the optimal solution exceeds a threshold. In some embodiments, the processing engine 112 may determine the optimal solution according to one or more algorithms. The one or more algorithms may include a gradient descent algorithm, a genetic algorithm, a particle swarm algorithm, a simulated annealing algorithm, or the like. The processing engine 112 may determine the starting distance, the cost for the starting distance, and the unit price corresponding to an optimal total turnover.

In some embodiments, by determining the service cost of the historical order corresponding to the distance range, an estimated order count corresponding to the distance range, and the preset constraint, the total turnover of the historical order may be determined. The processing engine 112 may determine whether the adjusted service cost improves the total turnover of a transport platform based on the total turnover of the historical order. The accuracy of the determining whether the total turnover is improved may be improved, which may improve the rationality of the determination of the preset service cost.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure.

FIG. 9 is a flowchart illustrating an exemplary process for optimizing a total turnover according to some embodiments of the present disclosure. In some embodiments, the process 900 may be implemented in the online to offline system 100. For example, the process 900 may be stored in the storage device 150 and/or the storage (e.g., the ROM 230, the RAM 240, etc.) as a form of instructions, and invoked and/or executed by the server 110 (e.g., the processing engine 112 in the server 110, or the processor 210 of the processing engine 112 in the server 110).

In 902, the processing engine 112 may obtain a service cost of each of historical orders, an estimated order count, and a total order count.

As used herein, the service cost of a historical order may refer to an actual service cost of the historical order payed by a service requestor after a service provider provides a service for the service requester. In other words, a historical order herein may have been completed. Each of the historical orders may correspond to a travel distance. In some embodiments, the service cost of each of the historical orders may be obtained from the storage device 150, the storage 390, or any other storage device as described elsewhere in the present disclosure. For example, the service cost of a historical order may be determined by a server associated with an online to offline platform. The server may transmit the service cost to a client terminal (e.g., the requestor terminal 130) associated with the online to offline platform and/or store the service cost in the storage device 150, the storage 390, or any other storage device as described elsewhere in the present disclosure. The server may be same as or different from the server 110. In some embodiments, the server may determine the service cost of a historical order based on a price rule associated with a travel distance. For example, the service cost of a historical order may be determined by multiplying the travel distance with a unit price per kilometer. As another example, the price rule may be determined based on different distance ranges such as a starting distance (e.g., 3 kilometers), a first distance (e.g., 50 kilometers), a second distance (e.g., 100 kilometers), etc. Different distance ranges may correspond to different pricing criteria. If the travel distance (e.g., 2.5 kilometers) of an order is smaller than the starting distance (e.g., 3 kilometers), the service cost of the order may equal to a constant (e.g., 6 RMB, 12 RMB, 15 RMB, etc.). If the travel distance (e.g., 45 kilometers) of an order exceeds the starting distance (e.g., 3 kilometers) and smaller than the first distance (e.g., 50 kilometers), a cost for a portion of the travel distance (e.g., 42 kilometers) that excludes the starting distance (e.g., 3 kilometers) may be determined by multiplying the portion the travel distance (e.g., 42 kilometers) with a first unit price per kilometer. The service cost of the order may be determined by summing costs corresponding to the starting distance (e.g., 3 kilometers) and the portion of the travel distance (e.g., 42 kilometers) that excludes the starting distance.

The estimated order count may be with respect to a service cost. Each of the historical orders may correspond to a service cost. In some embodiments, at least two historical orders may correspond to a same service cost. The processing engine 112 may statistically, determine multiple service costs of the historical orders. Then the processing engine 112 may obtain the estimated order count corresponding to each of the multiple distances from, for example, the storage device 150, the storage 390, or any other storage devices. For example, the estimated order count corresponding to each of the multiple service costs may be determined by the server different or same as the server 110 according to historical data during a time period before a historical time period corresponding to the historical orders. Then the server may transmit to and store the estimated order count corresponding to each of the multiple service costs in the storage device 150, the storage 390, or any other storage devices. The total order count may be with respect to the service cost. The total order count may correspond to each of the multiple service costs. The total order count may correspond to the estimated order count. The processing engine 112 may statistically, determine a count or number of historical orders (i.e., actual order count) corresponding to each of the multiple service costs. As used herein, the total order count may be also referred to as an actual order count.

In 904, the processing engine 112 may determine a relationship between a service cost and a conversion rate associated with the historical orders. The relationship between a service cost and a conversion rate may be denoted as a conversion rate model as described elsewhere in the present disclosure (e.g., FIG. 8 and the descriptions thereof). The conversation rate model may be used to determine and/or generate a probability that a server request or an order may be completed based on a service cost corresponding to the service request or an order.

In some embodiments, different service costs may correspond to different conversion rates. In some embodiments, the relationship between the service cost and the conversion rate (i.e., the conversation rate model) may be determined based on the historical orders using a fitting technique as described elsewhere in the present disclosure. Exemplary fitting techniques may include using a linear regression model, a naive Bayesian model, a GBDT model, an XGBOOST model, etc. The historical orders may correspond to multiple service costs obtained in 902. The processing engine 112 may determine a conversation rate corresponding to each of the multiple service costs. Then the processing engine 112 may fit the relationship between a conversation rate and a service costs based on the multiple service costs and the corresponding conversation rates using the fitting technique. The processing engine 112 may determine the conversation rate corresponding to each of the multiple service costs based on the actual order count and the estimated order count corresponding to each of the multiple service costs obtained in 902. For example, the conversation rate corresponding to each of the multiple service costs may be determined based on a ratio of the actual order count and the estimated order count corresponding to each of the multiple service costs. The fitted relationship between the service cost and the conversion rate (i.e., the conversation rate model) may be denoted as Equation (5):

Ratio=F(P), (5)

where P refers to the service cost; Ratio refers to the conversion rate; and function F refers to a constraint between the service cost and the conversation rate. In some embodiments, function F may be constructed based on a linear regression model, a naive Bayesian model, a GBDT model, an XGBOOST model, or the like. The processing engine 112 may determine the conversion rate for a specific service cost based on the function F.

In 906, the processing engine 112 may obtain data associated with one or more distance ranges and an estimated order count corresponding to each of the one or more distance ranges. In some embodiments, the processing engine 112 may determine multiple distance ranges based on travel distances of the historical orders. For example, the processing engine 112 may designate a range from 0 to the starting distance as a starting distance range. The processing engine 112 may designate a range from the starting distance to the first distance as a first distance range. The processing engine 112 may designate a range from the first distance to the second distance as a second distance range. As a further example, the multiple distance ranges may include the starting distance range (e.g., 0 kilometer-3 kilometers), the first distance range (e.g., 3 kilometers-50 kilometers), the second distance range (e.g., 50-100 kilometers), etc. Then the processing engine 112 may obtain the estimated order count corresponding to each of the multiple distances from, for example, the storage device 150, the storage 390, or any other storage devices. For example, the estimated order count corresponding to each of the multiple distance ranges may be determined by the server different or same as the server 110 according to historical data during a time period before a historical time period corresponding to the historical orders. Then the server may transmit to and store the estimated order count corresponding to each of the multiple distance ranges in the storage device 150, the storage 390, or any other storage devices.

In some embodiments, the processing engine 112 may further determine a relationship between a distance range and an estimated order count based on the distance ranges and the corresponding estimated order counts using a fitting technique as described elsewhere in the present disclosure. The relationship between a distance range and an estimated order count may be also referred to as an order count estimation model. The order count estimation model may be used to determine and/or generate an estimated order count corresponding to a distance range based on the distance range.

In some embodiments, when the platform grows to a certain stage, and/or the platform already occupies most of the market, demand and supply may be balanced. It is assumed that the change of the service cost does not affect the estimated order count, that is, the estimated order count for each distance range may be constant, the processing engine 112 may determine an estimated order count corresponding to a distance range according to Equation (6):

Estcnt=f(D), (6)

where D refers to a distance corresponding to the distance range; Estant refers to the estimated order count for the distance range; and f refers to the relationship between the estimated order count and the distance range.

In 908, the processing engine 112 may determine an estimated service cost for each of the distance ranges. The estimated service cost for each of the distance ranges may refer to a total turnover of all orders whose travel distances are within the each of the distance ranges. An estimated service cost for a specific distance range may be determined based on the conversation rate model and the order count estimation model determined in operation 904 and 906, respectively. For example, if each of orders corresponding to the specific distance range has a same cost, the estimated service cost for the specific distance range may be determined by multiplying the estimated order count corresponding to the specific distance range, the conversation rate corresponding to a service cost for the distance range, and the service cost.

In some embodiments, the multiple distance ranges may include the starting distance range (e.g., 0 kilometer-3 kilometers), the first distance range (e.g., 3 kilometers-50 kilometers), the second distance range (e.g., 50-100 kilometers), etc. The first distance range (e.g., 3 kilometers-50 kilometers) and the second distance range (e.g., 50-100 kilometers) may be also referred to as a distance range excluding the starting distance. Taken the starting distance range and the distance range excluding the starting distance as examples.

For the starting distance range, each of the plurality of orders may correspond to a same service cost. The processing engine 112 may determine the estimated service cost for the starting distance (GMV_s) based on the estimated order count corresponding to the starting distance, the conversation rate corresponding to the service cost for the starting distance, and the service cost. In some embodiments, the total turnover (i.e., estimated service cost) for the starting distance (GMV_s) may be a product of an actual order count for the starting distance and the service cost for the starting distance. The actual order count for the starting distance may be a product of an estimated order count for the starting distance and a conversion rate corresponding to the service cost for the starting distance. The estimated order count for the starting distance may be determined based on the estimated order count model determined in operation 906. The conversation rate for the service cost may be determined based on the conversation rate model determined in operation 904. For example, the total turnover for the starting distance (GMV_s) may be determined according to Equation (7):

GMV_s=P_s×Estant(D_s)×Ratio(P_s), (7)

where P_s refers to the service cost of each order whose travel distance is within the starting distance (i.e., the service cost for the starting distance); D_s refers to the starting distance; Estant(D_s) refers to the estimated order count for the starting distance; Ratio(P_s) refers to the conversion rate corresponding to the service cost for the starting distance. The actual order count for the starting distance may be determined according to Equation (8):

finishOrdCnt_s=Estant(D_s)×Ratio(P_s), (8)

where finishOrdCnt_s refers to the actual order count; P_s refers to the service cost for the starting distance; D_s refers to the starting distance; Estant(D_s) refers to the estimated order count for the starting distance; Ratio(P_s) refers to the conversion rate corresponding to the service cost for the starting distance. As used herein, the estimated service cost for the starting distance determined according to Equation (7) may be also referred to as an estimated service cost model for the starting distance. The estimated service cost model for the starting distance may provide a relationship between the starting distance, a service cost for the starting distance and an estimated total turnover. The estimated service cost model may be used to estimate and/or determine a total turnover for the starting distance based on the starting distance and the service cost for the starting distance. For example, the processing engine 112 may adjust the starting distance and/or the service cost for the starting distance. The conversation rate may be changed as the adjusted service cost for the starting distance. The estimated order count may be changed as the adjusted starting distance. Then the estimated total turnover for the starting distance may be changed.

In some embodiments, the processing engine 112 may determine the total turnover (GMV_n) for the distance excluding the starting distance. In some embodiments, the total turnover for the distance excluding the starting distance (GMV_n) may be a product of a service cost for each distance range and an order count for the each distance range. The service cost for the each distance range may be a product of a distance corresponding to the each distance range and a unit price. The order count for the each distance range may be a product of an estimated order count for the each distance range and a conversion rate corresponding to the service cost for the each distance range. In some embodiments, the total turnover for the distances excluding the starting distance (GMV_n) may be determined according to Equation (9):

GMV_n=(D−D_s)×X×Estant(D−D_s)×Ratio((D−Dₛ)×X), (9)

where D refers to the distance corresponding to a distance range; X refers to the unit price; (D−Dₛ)×X refers to the service cost for the distance range; Estant(D−D_s) refers to the estimated order count for the distance range; and Ratio((D−Dₛ)×X) refers to the conversion rate corresponding to the service cost for the distance range. The actual order count for the distances excluding the starting distance may be determined according to Equation (10):

finishOrdCnt_n=Estant(D−D_s)×Ratio((D−D_s)×X), (10)

where finishOrdCnt_n refers to the actual order count; D refers to the distance corresponding to the distance range; D_s refers to the starting distance; X refers to the unit price; (D−D_s)×X) refers to the service cost for the distance range; Estant(D−D_s) refers to the estimated order count for the distance range; and Ratio((D−Dₛ)×X) refers to the conversion rate corresponding to the service cost for the distance range. As used herein, the estimated service cost for the distance excluding the starting distance determined according to Equation (9) may be also referred to as an estimated service cost model for the distance excluding the starting distance. The estimated service cost model for the distance excluding the starting distance may provide a relationship between the distance excluding the starting distance, a unit price per kilometer, and an estimated total turnover. The estimated service cost model for the distance excluding the starting distance may be used to estimate and/or determine a total turnover for the distance excluding the starting distance based on the unit price per kilometer. For example, the processing engine 112 may adjust the unit price per kilometer. The service cost for the distance may be changed as the adjusted unit price per kilometer. The conversation rate may be changed as the adjusted service cost. Then the estimated total turnover for the distance excluding the starting distance may be changed.

In 910, the processing engine 112 may determine a total turnover optimization model.

In some embodiments, the processing engine 112 may determine a total turnover of a platform (e.g., an online to offline platform). Taking a taxi service in the platform as an example, a total turnover of an order in the taxi service may be a sum of a service cost for the starting distance of the order and a service cost for the distances excluding the starting distance of the order. The service cost for the starting distance may correspond to a certain starting distance (e.g., 5 kilometers, 10 kilometers, and 20 kilometers). In some embodiments, the total turnover may be determined according to Equation (11):

GMV=GMV_s+GMV_n, (11)

where GMV refers to the total turnover; GMV_s refers to the total turnover for the starting distance; and GMV_n refers to the total turnover for the distances excluding the starting distance. GMV_s and GMV_n may be determined as described in operation 908. In some embodiments, the actual order count may be determined according to Equation (12):

finishOrdCnt=finishOrdCnt_s+finishOrdCnt_n, (12)

where finishOrdCnt refers to the actual order count; finishOrdCnt_s refers to the actual order count for the starting distance; and finishOrdCnt_n refers to the actual order count for the distances excluding the starting distance.

In some embodiments, the processing engine 112 may determine the total turnover optimization model based on Equation (13) to Equation (20):

Max GMV (13)

s.t.GMV=GMV_s+GMV_n (14)

GMV_s=P_s×Estant×Ratio, (15)

GMV_n=(D−D_s)×X×Estant×Ratio, (16)

finishOrdCnt=finishOrdCnt_s+finishOrdCnt_n (17)

finishOrdCnt_s=Estant(D_s)×Ratio(P_s), (18)

finishOrdCnt_n=Estant(D−D_s)×Ratio((D−D_s)×X) (19)

predict finishOrdCnt [symbol] original finishOrdCnt (20)

In 912, the processing engine 112 may determine a starting distance, a cost for the starting distance, and a unit price based on the total turnover optimization model. The total turnover optimization model may provide a relationship between the starting distance, a service cost for the starting distance, a unit price per kilometers for the distance excluding the starting distance and a total turnover.

In some embodiments, the processing engine 112 may determine an optimal solution of the total turnover optimization model when a condition is satisfied. The optimal solution of the total turnover optimization model may be the starting distance, the service cost for the starting distance, a unit price per kilometers for the distance excluding the starting distance. In some embodiments, the condition may be such that the total service corresponding to the optimal solution exceeds a threshold. In some embodiments, the condition may be such that the total order count corresponding to the optimal solution exceeds a threshold. In some embodiments, the processing engine 112 may determine the optimal solution according to one or more algorithms. The one or more algorithms may include a gradient descent algorithm, a genetic algorithm, a particle swarm algorithm, a simulated annealing algorithm, or the like. The processing engine 112 may determine the starting distance, the cost for the starting distance, and the unit price corresponding to an optimal total turnover.

In some embodiments, under the premise that ensure the order count is not reduced, the starting distance, the cost for the starting distance, and the unit price may be controlled in a certain range. The processing engine 112 may determine the starting distance, the cost for the starting distance, and the unit price corresponding to the optimal total turnover in the certain range by using the total turnover optimization model.

In some embodiments, the total turnover optimization model may include one or more conditions. For example, the condition may include the increase of the total turnover is greater than a %. The processing engine 112 may determine the starting distance, the cost for the starting distance, and the unit price based on the condition and the total turnover optimization model.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure.

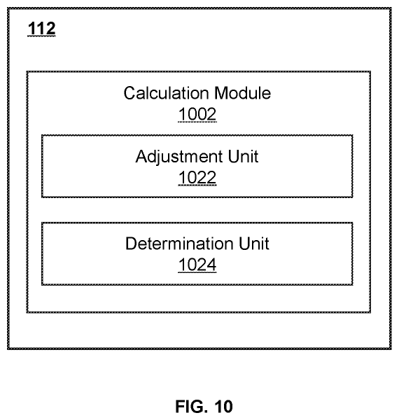

FIG. 10 is a block diagram illustrating an exemplary processing engine according to some embodiments of the present disclosure. In some embodiments, the processing engine 112 may include a calculation module 1002. The calculation module 1002 may include an adjustment unit 1022 and a determination unit 1024. The modules and/or the units may be hardware circuits of at least part of the processing engine 112. The modules and/or the units may also be implemented as an application or set of instructions read and executed by the processing engine 112. Further, the modules and/or the units may be any combination of the hardware circuits and the application/instructions. For example, modules and/or the units may be part of the processing engine 112 when the processing engine 112 is executing the application or set of instructions.

The calculation module 1002 may be configured to determine and/or adjust, based on a preset constraint between a total order count and a service cost, an estimated service cost associated with each of at least a portion of a plurality of orders, in response to information of the plurality of orders in a specific time period.

The adjustment unit 1022 may be configured to determine and/or adjust, based on a preset constraint, an estimated service cost associated with each of at least a portion of a plurality of orders until a total order count satisfies a preset order count.

The determination unit 1024 may be configured to determine a corresponding relationship between a total order count and a service cost associated with historical orders. The determination unit 1024 may be configured to determine a fitting function between a conversion rate and a service cost associated with historical orders. The determination unit 1024 may be configured to determine an estimated order count in each distance range corresponding to one of historical orders and a fitting function. The determination unit 1024 may be configured to determine, based on an estimated order count, a fitting function, and a corresponding relationship between a total order count and a service cost associated with historical orders, a preset constraint between the total order count and the estimated service cost.

In some embodiments, the estimated service cost associated with the each of at least a portion of the plurality of orders may be adjusted based on the preset constraint. Due to the preset constraint considers the influence of the estimated service cost on the service requestor (e.g., a passenger) and the service provider (e.g., a driver), that is, the relationship between the conversion rate and the service cost may be determined, the total order count may satisfy a preset order count by adjusting the estimated service cost. It is beneficial to improve the total turnover of a transport platform.

For example, in order to pursue a maximum total turnover, the processing engine 112 may reduce the service cost. The passenger may be more easily to accept the reduced service cost. However, it is more difficult for the driver to accept the reduced service cost, which may lead to a low conversion rate. The total order count and the total turnover may also be affected.

In some embodiments, the reliability of the determination of the total order count may be improved by determining the relationship between the service cost and the total order count.

In some embodiments, the conversion rates corresponding to different service costs may be determined based on the service cost associated with the historical orders, the total order count corresponding to the service cost associated with the historical orders, and the estimated order count associated with the historical orders. The fitting function between the conversion rate and the service cost may further be determined. The accuracy of determining the conversion rate may be improved. The accuracy of transport pricing may further be improved. The total turnover and the total order count of the transport platform may be increased, which may be conducive to increasing the market share of the transport platform.

In some embodiments, the fitting function between the conversion rate and the service cost with the service cost as an input and the conversion rate as an output may be determined according to a fitting technique. In some embodiments, the fitting function may be a linear regression model, a naive Bayesian model, a gradient boost decision tree (GBDT) model, an XGBOOST (e.g., an open source iterative tree algorithm) model, or the like. In some embodiments, the conversion rate may be increased by adjusting the estimated service cost. In some embodiments, the total turnover and the total order count of the transport platform may be increased by increasing the conversion rate.

As used herein, the estimated order count may refer to the number of orders that service requestors have input order information via client terminals (e.g., the requestor terminals 130) but has not yet initiated or formed. For example, a passenger may input a start location, a destination, and a start time via a user interface of the requestor terminal 130, and the order has not been confirmed and initiated by the passenger. The estimated order count may be determined based on the travel distance and/or the service cost of the order.

In some embodiments, by determining the service cost, the estimated order count, and the fitting function corresponding to the historical orders in the each distance range, the total turnover corresponding to the historical orders may be determined. The processing engine 112 may determine whether adjusted service cost improves the total turnover of the platform by using the total turnover of the historical orders as the benchmark for comparison. That is, the total turnover of the platform may be improved while improving the total order count of the platform, which may be beneficial to improving the promotion effect and market share of the platform.

In some embodiments, by determining the fitting function between the conversion rate and the service cost, a corresponding relationship between the total turnover and the total order count may be determined. The total turnover and the total order count may be increased by adjusting the estimated service cost.

It should be noted that the above description of the transport pricing device 400 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, the processing engine 112 may be a logical computing device such as a central processor (CPU), a digital signal processor (DSP), or a microcontroller (MCU). The calculation module 1002 may be a logical computing module of the processing engine 112. The determination unit 1024 may be a comparator of the processing engine 112. The adjustment unit 1022 may be a signal output port of the processing engine 112.

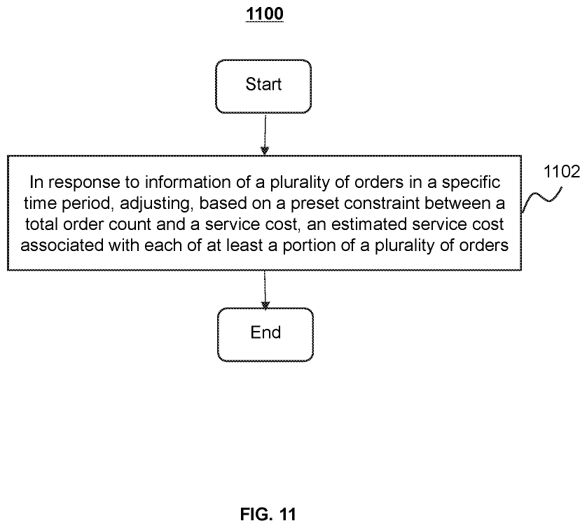

FIG. 11 is a flowchart illustrating an exemplary process for data processing according to some embodiments of the present disclosure. In some embodiments, the process 1100 may be implemented in the online to offline system 100. For example, the process 1100 may be stored in the storage device 150 and/or the storage (e.g., the ROM 230, the RAM 240, etc.) as a form of instructions, and invoked and/or executed by the server 110 (e.g., the processing engine 112 in the server 110, or the processor 210 of the processing engine 112 in the server 110).

In 1102, in response to information of a plurality of orders in a specific time period, the processing engine 112 may determine and/or adjust, based on a preset constraint between a total order count and a service cost, an estimated service cost associated with each of at least a portion of the plurality of orders.

In some embodiments, the estimated service cost associated with the each of at least a portion of the plurality of orders may be adjusted based on the preset constraint. Due to the preset constraint considers the influence of the estimated service cost on the service requestor (e.g., a passenger) and the service provider (e.g., a driver), that is, the relationship between the conversion rate and the service cost may be determined, the total order count may satisfy a preset order count by adjusting the estimated service cost. It is beneficial to improve the total turnover of a transport platform.

For example, in order to pursue a maximum total turnover, the processing engine 112 may reduce the service cost. The passenger may be more easily to accept the reduced service cost. However, it is more difficult for the driver to accept the reduced service cost, which may lead to a low conversion rate. The total order count and the total turnover may also be affected.

In some embodiments, the reliability of the determination of the total order count may be improved by determining the relationship between the service cost and the total order count.

In some embodiments, the specific time period may be a current time period with respect to the present moment. For example, the current time period may refer to a specific time range close to the present moment. As a further example, the specific time period may be 1 minute, 2 minutes, 3 minutes, 4 minutes, 5 minutes, 10 minutes, 20 minutes, 30 minutes, 60 minutes, etc., after and/or before the present moment. In some embodiments, the specific time period may be a future time period with respect to the present moment. For example, the specific time period may be 8:00 am-9:00 am tomorrow, tomorrow morning, tomorrow, the day after tomorrow, etc.

As used herein, an order may be also referred to as a service request as described in connection with operation 802. In some embodiments, the processing engine 112 may obtain the plurality of orders from the storage device 150, the client terminal (e.g., the requestor terminal 130, the service provider terminal 140) of one or more users via the network 120.

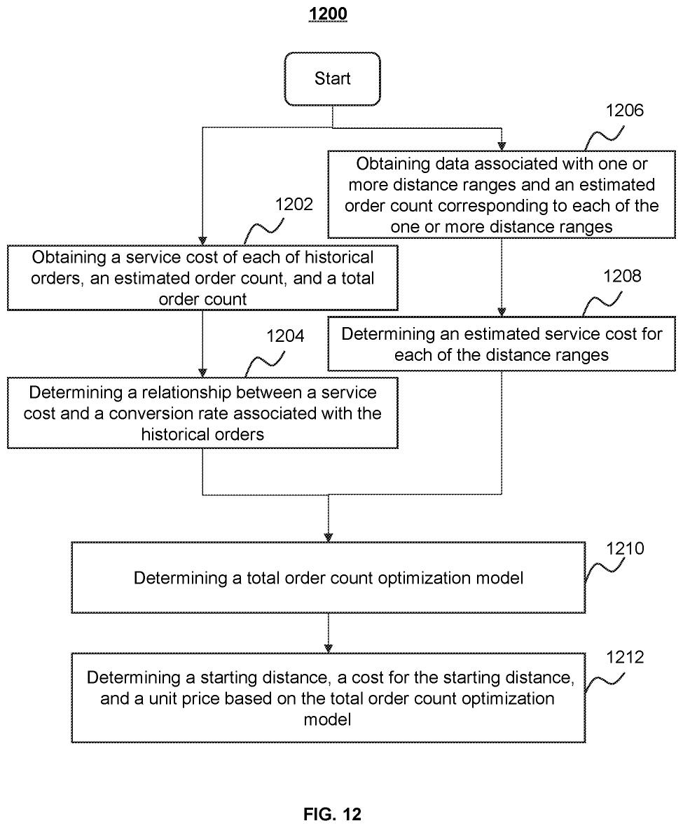

In some embodiments, each of the plurality of orders may correspond to an estimated service cost. The estimated service cost may be also referred to as a preset service cost. As used herein, “an (estimated) service cost of an order” may refer to an (estimated) revenue of the order. In some embodiments, the estimated service cost of an order may be determined according to a pricing rule as described in connection with operation 802. The estimated service cost may have a fitting relationship with an estimated starting distance, a cost for the estimated starting distance, and a unit price of distances excluding the estimated starting distance. The fitting relationship may be determined based on a service cost of each of historical orders, a historical starting distance of each of the historical orders, a cost for the historical starting distance of each of the historical orders, and a unit price of distances excluding the corresponding historical starting distance of each of the historical orders. More descriptions of the determination of the estimated starting distance, a cost for the estimated starting distance, and a unit price of distances excluding the estimated starting distance may be found elsewhere in the present disclosure (e.g., FIG. 12 and descriptions thereof).

In some embodiments, the processing engine 112 may determine and/or adjust the estimated service cost associated with the each of the at least a portion of the plurality of orders based on the preset constraint between the total order count and the service cost. In some embodiments, the processing engine 112 may determine and/or adjust, based on the preset constraint, the estimated service cost associated with the each of at least a portion of the plurality of orders until an estimated total turnover of the plurality of orders satisfies a condition and/or an estimated total count of formation orders among the plurality of orders satisfies a condition. In some embodiments, the estimated total turnover of the plurality of orders satisfying the condition may include that the estimated total turnover exceeds a preset total turnover. The estimated total count of formation orders among the plurality of orders satisfying the condition may include the estimated total count of formation orders exceeds a preset order count in the specific time period. In some embodiments, the estimated total turnover of the plurality of orders satisfying the condition may include that an increase of the estimated total turnover after adjusting the estimated service cost exceeds a threshold. The estimated total count of formation orders among the plurality of orders satisfying the condition may include an increase of the estimated total count of formation orders after adjusting the estimated service cost exceeds a threshold. In some embodiments, the processing engine 112 may further adjust the estimated service cost to determine a target estimated service cost for the each of the at least a portion of the plurality of orders. In some embodiments, the preset constraint may be a fitting relationship between the service cost and the total order count with the service cost as an input and the total order count as an output. For example, the preset constraint may be a fitting relationship between the service cost and the total order count. As another example, the preset constraint may be a fitting relationship between a range of the service cost and a range of the total order count. The processing engine 112 may determine whether the output (e.g., the total order count) is greater than the preset order count based on the input (e.g., the service cost). In response to a determination that the output (e.g., the total order count) is greater than the preset order count, the processing engine 112 may determine the corresponding service cost as the target service cost (e.g., the adjusted estimated service cost).

In some embodiments, the processing engine 112 may determine the preset constraint based on information of a plurality of historical orders. The plurality of historical orders may be provided by an online to offline platform in a historical time period. The historical time period may be a day, a week, a month, a quarter, etc., before the present moment or the specific time period as described above. In some embodiments, the processing engine 112 may determine the preset constraint based on a corresponding relationship between the total order count and a service cost associated with historical orders, a fitting function between a conversion rate and the service cost associated with the historical orders, an estimated order count in each distance range corresponding to one of the historical orders, and the fitting function. In some embodiments, before responding to the information of the plurality of orders in the specific time period, the processing engine 112 may determine the corresponding relationship between the total order count and a service cost associated with historical orders. For example, each of the historical orders may correspond to a service cost. The processing engine 112 may statistically, determine an actual order count corresponding to a same service cost. The processing engine 112 may further determine a fitting function between a conversion rate and the service cost associated with the historical orders. The conversation rate may be used to reflect a probability that a service request has been completed. The conversation rate may be also referred to an order forming conversation rate. The processing engine 112 may denote the relationship between a service cost and a conversion rate as a conversation rate model. The conversation rate model may provide the relationship between a service cost and a conversion rate. In some embodiments, the processing engine 112 may fit the relationship between the service cost and the order forming conversion rate using a first machine learning model with the service cost as described in connection with operation 904. The processing engine 112 may determine a conversation rate corresponding to the same service cost based on an actual order count corresponding to the same service cost and an estimated service cost corresponding to the same service cost. As used herein, the conversion rate corresponding to a service cost may refer to a ratio of a total order count to the estimated order count corresponding to a service cost. Similarly, the processing engine 112 may determine multiple groups of conversation rates and service costs based on the historical orders. Then the processing engine 112 may fit the relationship between a conversation rate and a service cost based on the determined multiple groups of conversation rates and service costs using the first machine learning model. As used herein, the estimated order count may refer to the number of orders that service requestors have input order information via client terminals (e.g., the requestor terminals 130) but has not yet initiated or formed. For example, a passenger may input a start location, a destination, and a start time via a user interface of the requestor terminal 130, and the order has not been confirmed and initiated by the passenger. The estimated order count may be determined based on the travel distance and/or the service cost of the order.

The processing engine 112 may determine an estimated order count in each distance range corresponding to one of the historical orders and the fitting function. For example, the processing engine 112 may determine a mapping relationship (e.g., the fitting function) between the distance range and an estimated order count based on the historical orders. For example, the processing engine 112 may determine the mapping relationship between the distance range and the estimated order count by using a second machine learning model, as described in connection with operation 1206. As a further example, each of the plurality of historical orders may correspond to a distance range. The processing engine 112 may statistically, determine an order count corresponding to a same distance range from the plurality of historical orders. Similarly, the processing engine 112 may determine multiple groups of order counts and travel distances. The processing engine 112 may fit the mapping relationship between a distance range and an estimated order count using the second machine learning model based on the multiple groups of order counts and distance ranges.

The first machine learning model and/or the second machine learning model may be constructed based on a linear regression model, a naive Bayesian model, a gradient boost decision tree (GBDT) model, a XGBOOST model, an artificial neural network, a support vector machine (SVM) model, a genetic model, or the like, or any combination thereof. The processing engine 112 may determine, based on the estimated order count, the fitting function, and the corresponding relationship between the total order count and the service cost associated with the historical orders, the preset constraint between the total order count and the estimated service cost.

In some embodiments, the conversion rates corresponding to different service costs may be determined based on the service cost associated with the historical orders, the total order count corresponding to the service cost associated with the historical orders, and the estimated order count associated with the historical orders. The fitting function between the conversion rate and the service cost may further be determined. The accuracy of determining the conversion rate may be improved. The accuracy of transport pricing may further be improved. The total turnover and the total order count of the transport platform may be increased, which may be conducive to increasing the market share of the transport platform.

In some embodiments, the fitting function between the conversion rate and the service cost with the service cost as an input and the conversion rate as an output may be determined according to a fitting technique. In some embodiments, the fitting function may be a linear regression model, a naive Bayesian model, a gradient boost decision tree (GBDT) model, an XGBOOST (e.g., an open source iterative tree algorithm) model, or the like. In some embodiments, the conversion rate may be increased by adjusting the estimated service cost. In some embodiments, the total turnover and the total order count of the transport platform may be increased by increasing the conversion rate.

In some embodiments, the preset constraint may be determined according to Equation (21):

finishOrdCnt=Σ₁ⁿEstcntᵢ(D)×Ratioᵢ(P(D)), (21)

where finishOrdCnt refers to the total order count, Estcntᵢ(D) refers to an estimated order count corresponding to iₜₕ historical order, Ratioᵢ(P(D)) refers a conversion rate corresponding to iₜₕ historical order; D refers a service distance corresponding to iₜₕ historical order; P(D) refers a service cost corresponding to iₜₕ historical order; and n refers to the total order count of the historical orders, n being an positive integer [symbol] 1.

The preset constraint may be used to estimate and/or determine the total order count associated with the each of at least a portion of the plurality of orders based on a starting distance, a service cost for the starting distance, and a unit price per kilometers for the distance excluding the starting distance determined in process 1200. For example, the processing engine 112 may adjust the starting distance, the service cost for the starting distance, and the unit price per kilometers for the distance excluding the starting distance. The conversation rate may be changed as the adjusted service cost for the starting distance and the adjusted unit price per kilometers for the distance excluding the starting distance. The estimated order count may be changed as the adjusted starting distance. Then the total order count associated with the each of at least a portion of the plurality of orders may be changed.

In some embodiments, the processing engine 112 may determine an optimal solution of the preset constraint when a condition is satisfied. The optimal solution of the preset constraint may be the starting distance, the service cost for the starting distance, and the unit price per kilometers for the distance excluding the starting distance. In some embodiments, the condition may be such that the total turnover corresponding to the optimal solution exceeds a threshold. In some embodiments, the condition may be such that the total order count corresponding to the optimal solution exceeds a threshold. In some embodiments, the processing engine 112 may determine the optimal solution according to one or more algorithms. The one or more algorithms may include a gradient descent algorithm, a genetic algorithm, a particle swarm algorithm, a simulated annealing algorithm, or the like. The processing engine 112 may determine the starting distance, the cost for the starting distance, and the unit price corresponding to an optimal total order count.

In some embodiments, by determining the service cost, the estimated order count, and the fitting function corresponding to the historical orders in the each distance range, the total turnover corresponding to the historical orders may be determined. The processing engine 112 may determine whether adjusted service cost improves the total turnover of the platform by using the total turnover of the historical orders as the benchmark for comparison. That is, the total turnover of the platform may be improved while improving the total order count of the platform, which may be beneficial to improving the promotion effect and market share of the platform.

In some embodiments, by determining the fitting function between the conversion rate and the service cost, a corresponding relationship between the total turnover and the total order count may be determined. The total turnover and the total order count may be increased by adjusting the estimated service cost.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure.

FIG. 12 is a flowchart illustrating an exemplary process for optimizing a total order count according to some embodiments of the present disclosure. In some embodiments, the process 1200 may be implemented in the online to offline system 100. For example, the process 1200 may be stored in the storage device 150 and/or the storage (e.g., the ROM 230, the RAM 240, etc.) as a form of instructions, and invoked and/or executed by the server 110 (e.g., the processing engine 112 in the server 110, or the processor 210 of the processing engine 112 in the server 110).

In 1202, the processing engine 112 may obtain a service cost of each of historical orders, an estimated order count, and a total order count.

More descriptions of the service cost of a historical order, the estimated order count, and the total order count may be found elsewhere in the present disclosure (e.g., operation 902 in FIG. 9, and descriptions thereof).

In 1204, the processing engine 112 may determine a relationship between a service cost and a conversion rate associated with the historical orders. The relationship between a service cost and a conversion rate may be denoted as a conversion rate model. More descriptions of the determination of the relationship between the service cost and the conversion rate associated with the historical orders may be found elsewhere in the present disclosure (e.g., operation 904 in FIG. 9, and descriptions thereof).

In 1206, the processing engine 112 may obtain data associated with one or more distance ranges and an estimated order count corresponding to each of the one or more distance ranges.

In some embodiments, the processing engine 112 may determine a relationship between a distance range and an estimated order count based on the distance ranges and the corresponding estimated order counts using a fitting technique as described elsewhere in the present disclosure. The relationship between a distance range and an estimated order count may be also referred to as an order count estimation model. More descriptions of the determination of the distance range and the relationship between the distance range and the estimated order count may be found elsewhere in the present disclosure (e.g., operation 906 in FIG. 9, and descriptions thereof).

In 1208, the processing engine 112 may determine an estimated service cost for each of the distance ranges.

More descriptions of the determination of the estimated service cost for the each of the distance ranges may be found elsewhere in the present disclosure (e.g., operation 908 in FIG. 9, and descriptions thereof).

In 1210, the processing engine 112 may determine a total order count optimization model.

In some embodiments, the processing engine 112 may determine a total turnover of a platform (e.g., an online to offline platform) according to Equation (11) as described in connection with operation 910. In some embodiments, the processing engine 112 may determine the total order count according to Equation (12) as described in connection with operation 910.

In some embodiments, the processing engine 112 may determine the total order count optimization model based on Equation (22) to Equation (29):

Max finishOrdCnt (22)

finishOrdCnt=finishOrdCnt_s+finishOrdCnt_n (23)

finishOrdCnt_s=Estant(D_s)×Ratio(P_s) (24)

finishOrdCnt_n=Estant(D−D_s)×Ratio((D−D_s)×X) (25)

s.t.GMV=GMV_s+GMV_n (26)

GMV_s=P_s×Estant×Ratio, (27)

GMV_n=(D−D_s)×X×Estant×Ratio, (28)

predict GMV [symbol] original GMV (29)

In 1212, the processing engine 112 may determine a starting distance, a cost for the starting distance, and a unit price based on the total order count optimization model.

The total order count optimization model may provide a relationship between the starting distance, a service cost for the starting distance, a unit price per kilometers for the distance excluding the starting distance and a total order count. In some embodiments, the processing engine 112 may determine an optimal solution of the total order count optimization model when a condition is satisfied. The optimal solution of the total order count optimization model may be the starting distance, the service cost for the starting distance, and a unit price per kilometers for the distance excluding the starting distance. In some embodiments, the condition may be such that the total turnover corresponding to the optimal solution exceeds a threshold. In some embodiments, the condition may be such that the total order count corresponding to the optimal solution exceeds a threshold. In some embodiments, the processing engine 112 may determine the optimal solution according to one or more algorithms. The one or more algorithms may include a gradient descent algorithm, a genetic algorithm, a particle swarm algorithm, a simulated annealing algorithm, or the like. The processing engine 112 may determine the starting distance, the cost for the starting distance, and the unit price corresponding to an optimal total order count.

In some embodiments, under the premise that ensure the total turnover is not reduced, the starting distance, the cost for the starting distance, and the unit price may be controlled in a certain range. The processing engine 112 may determine the starting distance, the cost for the starting distance, and the unit price corresponding to the optimal total order count in the certain range by using the total order count optimization model.

In some embodiments, the total order count optimization model may include one or more conditions. For example, the condition may include the increase of the total order count is greater than a %. The processing engine 112 may determine the starting distance, the cost for the starting distance, and the unit price based on the condition and the total order count optimization model.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “module,” “unit,” “component,” “device,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claim subject matter lie in less than all features of a single foregoing disclosed embodiment.

1-8. (canceled)

9. A system for data processing, comprising:
at least one storage medium storing a set of instructions;
at least one processor in communication with the at least one storage medium, when executing the stored set of instructions, the at least one processor is configured to cause the system to perform operations including:
in response to information of a plurality of orders in a specific time period, determining, based on a preset constraint between a total turnover and a service cost, an estimated service cost associated with each of at least a portion of the plurality of orders.

10-17. (canceled)

18. A system for data processing, comprising:
at least one storage medium storing a set of instructions;
at least one processor in communication with the at least one storage medium, when executing the stored set of instructions, the at least one processor is configured to cause the system to perform operations including:
in response to information of a plurality of orders in a specific time period, adjusting, based on a preset constraint between a total order count and a service cost, an estimated service cost associated with each of at least a portion of the plurality of orders.

19-28. (canceled)

29. A system for transport pricing, comprising:
at least one storage medium storing a set of instructions;
at least one processor in communication with the at least one storage medium, when executing the stored set of instructions, the at least one processor is configured to cause the system to perform operations including:
determining an actual service cost and a preset service cost of each of historical orders, and an actual order count corresponding to the preset service cost;
determining, based on the actual service cost of each of the historical orders, an actual total turnover; and
determining a fitting function with the total turnover as a dependent variable, and a conversion rate and a price adjustment ratio as independent variables, wherein the conversion rate denotes a ratio of the actual order count and an estimated order count, and the price adjustment ratio is a ratio of the actual service cost and the preset service cost.

30-31. (canceled)

32. The system of claim 9, wherein the estimated service cost has a fitting relationship with an estimated starting distance, a cost for the estimated starting distance, and a unit price of distances excluding the estimated starting distance, and the fitting relationship is determined based on a service cost of each of historical orders, a historical starting distance of each of the historical orders, a cost for the historical starting distance of each of the historical orders, and a unit price of distances excluding the corresponding historical starting distance of each of the historical orders.

33. The system of claim 9, wherein the determining, based on a preset constraint between a total turnover and a service cost, an estimated service cost associated with the each of at least a portion of the plurality of orders includes:
determining, based on the preset constraint, a range of the estimated service cost associated with the each of at least a portion of the plurality of orders when an estimated total turnover exceeds a preset total turnover and an estimated order count exceeds a preset order count in the specific time period.

34. The system of claim 32, wherein the preset constraint is determined by:
obtaining data associated with the historical orders;
determining, statistically, a relationship between the service cost and a conversion rate based on the data associated with the historical orders;
determining a mapping relationship between a travel distance and an estimated order count based on the data associated with the historical orders; and
determining, based on the relationship between the service cost and the conversion rate and the mapping relationship between the travel distance and the estimated order count associated with the historical orders, the preset constraint.

35. The system of claim 34, wherein the determining, based on the relationship between the service cost and the conversion rate and the mapping relationship between the travel distance and the estimated order count associated with the historical orders, the preset constraint includes:
analyzing, corresponding to the service cost of each of the historical orders, the historical starting distance of each of the historical orders, the cost for the historical starting distance of each of the historical orders, and the unit price of distances excluding the corresponding historical starting distance of each of the historical orders; and
determining, based on the service cost of each of the historical orders, the historical starting distance of each of the historical orders, the cost for the historical starting distance of each of the historical orders, the unit price of distances excluding the corresponding historical starting distance of each of the historical orders, the relationship between the service cost and the conversion rate associated with the historical orders, and the mapping relationship between the travel distance and the estimated order count associated with the historical orders, the preset constraint.

36. The system of claim 34, wherein the determining, statistically, a relationship between the service cost and a conversion rate based on the data associated with the historical orders includes:
determining the conversion rate corresponding to the service cost of each of the historical orders; and
determining, based on the service cost of each of the historical orders and the determined conversion rate corresponding to the service cost of each of the historical orders, the relationship between the conversion rate and the service cost;
wherein the conversion rate is determined based on a ratio of a total order count associated with the historical orders to the estimated order count associated with the historical orders.

37. The system of claim 34, wherein the determining a mapping relationship between a travel distance and an estimated order count based on the data associated with the historical orders includes:
determining the estimated order count corresponding to the travel distance of each of the historical orders; and
determining, based on the travel distance of each of the historical orders and the determined estimated order count corresponding to the travel distance of each of the historical orders, the mapping relationship between the travel distance and the estimated order count.

38. The system of claim 18, wherein the adjusting, based on a preset constraint between a total order count and a service cost, an estimated service cost associated with each of at least a portion of the plurality of orders includes:
adjusting, based on the preset constraint, the estimated service cost associated with the each of at least a portion of the plurality of orders until the total order count satisfies a preset order count.

39. The system of claim 18, wherein before responding to the information of the plurality of orders in the specific time period, the at least one processor is further configured to cause the system to perform operations including:
determining a corresponding relationship between the total order count and the service cost based on historical orders;
determining a fitting function between a conversion rate and the service cost based on the historical orders; and
determining, based on the corresponding relationship between the total order count and the service cost and the fitting function between the conversion rate and the service cost, the preset constraint.

40. The system of claim 39, wherein the determining a fitting function between a conversion rate and the service cost based on the historical orders includes:
determining the conversion rate corresponding to the service cost of each of the historical orders; and
determining, based on the service cost of each of the historical orders and the determined conversion rate corresponding to the service cost of each of the historical orders, the fitting function between the conversion rate and the service cost,
wherein the conversion rate corresponding to the service cost is determined based on a ratio of a total order count to the estimated order count a fitting function between a conversion rate and the service cost corresponding to the service cost.

41. The system of claim 39, wherein the determining, based on the corresponding relationship between the total order count and the service cost and the fitting function between the conversion rate and the service cost, the preset constraint includes:
determining an estimated order count in each distance range corresponding to one of the historical orders and the fitting function; and
determining, based on the estimated order count, the fitting function, and the corresponding relationship between the total order count and the service cost associated with the historical orders, the preset constraint between the total order count and the estimated service cost.

42. The system of claim 29, wherein the at least one processor is further configured to cause the system to perform operations including:
for each of the historical orders, detecting whether a client terminal associated with a passenger confirms the receipt of the price adjustment ratio and initiates the each of the historical orders to determine a demand conversion rate;
detecting whether a client terminal associated with a driver confirms the receipt of the price adjustment ratio and the each of the historical orders to determine the conversion rate; and
fitting the demand conversion rate and the conversion rate to determine a first corresponding relationship between the price adjustment ratio and the conversion rate.

43. The system of claim 29, wherein the at least one processor is further configured to cause the system to perform operations including:
determining the preset service cost, a preset demand amount corresponding to the preset service cost, and an actual demand amount;
determining a ratio between the preset demand amount and the actual demand amount; and
fitting the preset service cost and the ratio between the preset demand amount and the actual demand amount to determine a second corresponding relationship.

44. The system of claim 43, wherein the at least one processor is further configured to cause the system to perform operations including:
determining, based on an operation time corresponding to each of the historical orders, a distribution function of the actual demand amount with respect to a specific time period.

45. The system of claim 44, wherein the determining a fitting function with the total turnover as a dependent variable, and a conversion rate and a price adjustment ratio as independent variables includes:
determining a product between the first relationship, the second relationship, the preset service cost, and the price adjustment ratio with respect to the specific time period;
determining an accumulation of the product when the preset service cost satisfies a discrete distribution; and
multiplying the accumulation and the distribution function of the actual demand amount to determine the total turnover.

46. The system of claim 44, wherein the determining a fitting function with the total turnover as a dependent variable, and a conversion rate and a price adjustment ratio as independent variables includes:
determining a product between the first relationship, the second relationship, the preset service cost, and the price adjustment ratio with respect to the specific time period;
performing an integral operation on the product when the preset service cost satisfies a continuous distribution; and
multiplying an integral result and the distribution function of the actual demand amount to determine the total turnover, wherein a maximum of the preset service cost an integral range of the integral operation ≥0.

47. The system of claim 29, wherein the determining a fitting function with the total turnover as a dependent variable, and a conversion rate and a price adjustment ratio as independent variables includes:
determining a conversion rate model providing a relationship between a conversion rate and a service cost based on the actual service cost and the preset service cost of each of the historical orders, and the actual order count corresponding to the preset service cost;
determining a demand amount distribution model based on the historical orders, the demand amount distribution model providing a relationship between the service cost, an estimated demand amount and an actual demand amount;
determining an actual demand amount model providing a relationship between the actual demand amount and a time period; and
determining the fitting function based on the conversion rate model, the demand amount distribution model, and the actual demand amount model.

48. The system of claim 29, wherein the at least one processor is further configured to cause the system to perform operations including:
obtaining one or more specific orders;
determining a price adjustment ratio for each of at least a portion of the one or more specific orders based on the fitting function; and
adjusting a preset service cost for each of at least a portion of the one or more specific orders based on the determined price adjustment ratio.
